(19) United States
(12) Patent Application Publication
(10) Pub. No.: US 2026/0235791 A1
(43) Pub. Date: Aug. 13, 2026

(54) OPTICAL LAMINATE AND POLARIZING PLATE, SURFACE PLATE, IMAGE DISPLAY PANEL, AND IMAGE DISPLAY DEVICE USING SAID OPTICAL LAMINATE

(71) Applicant: DAI NIPPON PRINTING CO., LTD., Tokyo (JP)

(72) Inventors: Yumi TAKAGI, Chiryu-shi, Aichi (JP); Shintaro NASU, Ichikawa-shi, Chiba (JP); Tomoyuki HORIO, Tsukuba-shi, Ibaraki (JP); Tomohiro OGAWA, Tsukuba-shi, Ibaraki (JP); Mitsuhiro KUZUHARA, Okayama-shi, Okayama (JP); Hiroyuki HASEGAWA, Kashiwa-shi, Chiba (JP); Masato OKADA, Tsukuba-shi, Ibaraki (JP)

(21) Appl. No.: 19/159,928

(22) PCT Filed: Feb. 29, 2024
(86) PCT No.: PCT/JP2024/007546

§ 371 Date: Aug. 26, 2025

(30) Foreign Application Priority Data
Mar. 2, 2023 (JP) 2023-031727

(51) Int. Cl. G02B 1/111; G02B 1/04; G02B 5/30; G02F 1/1335

(52) U.S. Cl. CPC G02B 1/111; G02B 1/04; G02F 1/133502; G02B 5/3025

(57) ABSTRACT

Provided is an optical laminate that includes a low refractive index layer laminated on an anti-glare layer and that achieves sufficient anti-reflection properties. An optical laminate comprising a first side and a second side on the opposite side to the first side, wherein the optical laminate comprises a low refractive index layer and an anti-glare layer in this order, from the first side to the second side, the low refractive index layer comprises a binder resin and spherical particles having an average particle size of 20 nm or more, the first side has an uneven shape, an “average occupied area ratio of the spherical particles having an average particle size of 20 nm or more” is 15.0% or more, and an “average film thickness of the low refractive index layer” is 200 nm or less, and an “average standard deviation of a film thickness of the low refractive index layer” is 25.0 nm or less.

### TECHNICAL FIELD

The present disclosure relates to an optical laminate, and a polarizing plate, a surface plate, an image display panel, and an image display device using the optical laminate.

### BACKGROUND ART

An optical laminate may be provided, on the surface of an image display device such as a monitor of a television, a laptop PC or a desktop PC for suppressing reflection of a background such as illumination or person, and for suppressing surface reflection.

An anti-glare film having an uneven shape has been proposed as an optical laminate for suppressing reflection of a background. However, an anti-glare film has a problem that contrast is easily reduced due to the scattering of reflected light.

An anti-reflection film having an anti-reflection layer on the surface has been proposed as an optical laminate for suppressing surface reflection. However, an anti-reflection film has a problem that reflection of a background is difficult to suppress due to the smooth surface shape thereof.

As an optical laminate for suppressing reflection of a background and surface reflection, an anti-glare anti-reflection film in which an anti-reflection layer, such as a low refractive index layer, is laminated on an anti-glare layer has been proposed (PTL 1 and 2, etc.)

### CITATION LIST

### Patent Literature

PTL 1: JP 2010-8757 A
PTL 2: JP 2020-122926 A

### SUMMARY OF INVENTION

### Technical Problem

Optical laminates of PTL 1 to 2 have an anti-reflection layer on an anti-glare layer, and hence can suppress both reflection of a background and surface reflection. However, in a conventional optical laminate in which an anti-reflection layer is laminated on an anti-glare layer, as in the optical laminates of PTL 1 to 2, anti-reflection properties at a level expected at the stage of coating film design cannot be frequently obtained. Particularly, there has been a tendency that the anti-reflection properties at a level expected at the stage of coating film design are more difficult to be obtained, as the level of unevenness in the anti-glare layer is higher. The anti-reflection properties at a level expected at the stage of coating film design refer to a reflectance calculated through simulation based on physical information from the coating film design, such as a theoretical refractive index and a theoretical film thickness.

An object of the present disclosure is to provide an optical laminate that includes a low refractive index layer laminated on an anti-glare layer and that achieves sufficient anti-reflection properties.

### Solution to Problem

The present disclosure provides the following <1> to <5>:

<1> An optical laminate comprising a first side and a second side on the opposite side to the first side, wherein
the optical laminate comprises a low refractive index layer and an anti-glare layer in this order, from the first side to the second side,
the low refractive index layer comprises a binder resin and spherical particles having an average particle size of 20 nm or more,
the first side has an uneven shape,
an “average occupied area ratio of the spherical particles having an average particle size of 20 nm or more” calculated through the following Measurement 1 is 15.0% or more, and
an “average film thickness of the low refractive index layer” is 200 nm or less and an “average standard deviation of a film thickness of the low refractive index layer” is 25.0 nm or less, calculated through the following Measurement 2:

### <Measurement 1>

(1-1) a surface on the first side of the optical laminate is imaged with a scanning electron microscope; an imaging area is adjusted in such a manner that a region excluding a scale bar is 50.79 μm in width×38.10 μm in height; the region of 50.79 μm in width×38.10 μm in height is further adjusted to have a pixel number of 1280 pixels×890 pixels;
(1-2) an image of the region of 50.79 μm in width×38.10 μm in height of the (1-1) is divided into 256 gradations, with a darkest part set to 0 and a brightest part set to 255; the image of the region of 50.79 μm in width×38.10 μm in height of the (1-1) is divided into “10 in width×10 in height=100” small regions; a standard deviation of the gradations is calculated for each of 64 small regions, excluding 36 small regions located on an outer periphery, out of the 100 small regions; a small region with a largest standard deviation of the gradations among the 64 small regions is specified; and among the 64 small regions, “3 in width×3 in height=9” small regions centered around the small region with the largest standard deviation of the gradations are regarded as a convex portion of the low refractive index layer and a neighboring region thereof;
(1-3) the “convex portion and a neighboring region thereof” of the (1-2) is further divided into “10 in width×10 in height=100” fine regions; a standard deviation of the gradations is calculated for each of the 100 fine regions; the gradations for step (1-3) use the 256 gradations of the (1-2); and a fine region with a largest standard deviation of the gradations is specified among the 100 fine regions;
(1-4) an image of a region of 1270 nm in width×890 nm in height, centered around a center part of the fine region specified in the (1-3), is captured with a scanning electron microscope; a portion of the low refractive index layer within the image of the region of 1270 nm in width×890 nm in height is regarded as a convex portion of the low refractive index layer; and a ratio of an area occupied by the spherical particles having an average particle size of 20 nm or more in the region of 1270 nm in width×890 nm in height is calculated; and
(1-5) operations described above in the (1-1) to (1-4) are performed at 20 positions on a surface of the first side of the optical laminate; and an average of the ratios of the areas at 18 positions, excluding minimum and maximum values, is defined as the “average occupied area ratio of the spherical particles having an average particle size of 20 nm or more”;

### <Measurement 2>

(2-1) a vertical cross-section of the optical laminate is imaged with a scanning transmission electron microscope; and an image is adjusted in such a manner that a region excluding a scale bar is 254 μm in width×178 μm in height;
(2-2) in the image of the region of 254 μm in width×178 μm in height of the (2-1), a position where the low refractive index layer is thickest is specified;
(2-3) an image of a region of 1270 nm in width×890 nm in height, centered around the position specified in the (2-2), is captured with a scanning transmission electron microscope; a portion of the low refractive index layer within the image of the region of 1270 nm in width×890 nm in height is regarded as a concave portion of the low refractive index layer; in the region of 1270 nm in width×890 nm in height, a film thickness of the low refractive index layer and a standard deviation of the film thickness of the low refractive index layer are calculated; the film thickness of the low refractive index layer is defined as an average value of film thicknesses at 25 positions; similarly, the standard deviation of the film thickness of the low refractive index layer is defined as a standard deviation of the film thicknesses at 25 positions; and the 25 positions are selected at 50 nm intervals within a range of the length of 1270 nm in width; and
(2-4) operations described above in the (2-1) to (2-3) are performed at 20 positions on the vertical cross-section of the optical laminate; and an average of the film thicknesses and an average of the standard deviations of the film thicknesses at 18 positions, excluding minimum and maximum values, are defined respectively as the “average film thickness of the low refractive index layer” and the “average standard deviation of the film thickness of the low refractive index layer”.
<2> A polarizing plate comprising:
a polarizer;
a first transparent protective plate disposed on one side of the polarizer; and
a second transparent protective plate disposed on the other side of the polarizer, wherein
at least one of the first transparent protective plate and the second transparent protective plate is the optical laminate according to <1>, and
the second side of the optical laminate and the polarizer are disposed so as to face each other.
   <3> A surface plate for an image display device, the surface plate comprising:
a resin plate or a glass plate; and
a protective film bonded to the resin plate or the glass plate, wherein
the protective film is the optical laminate according to <1>, and
the second side of the optical laminate and the resin plate or the glass plate are disposed so as to face each other.
   <4> An image display panel comprising a display element and an optical laminate disposed on a light-emitting surface side of the display element, wherein the image display panel comprises, as the optical laminate, the optical laminate according to <1>.
   <5> An image display device comprising the image display panel according to <4>.

### Advantageous Effects of Invention

The optical laminate, the polarizing plate, the surface plate, the image display panel, and the image display device of the present disclosure can achieve good anti-reflection properties.

### BRIEF DESCRIPTION OF DRAWINGS

FIG. 1 is a schematic cross-sectional view showing one embodiment of an optical laminate of the present disclosure.

FIG. 2 is a cross-sectional view showing one embodiment of an image display panel of the present disclosure.

FIG. 3 is a diagram for explaining Measurement 1.

### DESCRIPTION OF EMBODIMENTS

Embodiments of the present disclosure will be described below.

Herein, the “average occupied area ratio of spherical particles having an average particle size of 20 nm or more” may be abbreviated as the “average occupied area ratio.”

### [Optical Laminate]

An optical laminate of the present disclosure is as follows:

An optical laminate comprising a first side and a second side on the opposite side to the first side, wherein
the optical laminate comprises a low refractive index layer and an anti-glare layer in this order, from the first side to the second side,
the low refractive index layer comprises a binder resin and spherical particles having an average particle size of 20 nm or more,
the first side has an uneven shape,
an “average occupied area ratio of the spherical particles having an average particle size of 20 nm or more” calculated through the following Measurement 1 is 15.0% or more, and
an “average film thickness of the low refractive index layer” is 200 nm or less and an “average standard deviation of a film thickness of the low refractive index layer” is 25.0 nm or less, calculated through the following Measurement 2.

### <Measurement 1>

(1-1) A surface on the first side of the optical laminate is imaged with a scanning electron microscope. An imaging area is adjusted in such a manner that a region excluding a scale bar is 50.79 μm in width×38.10 μm in height. The region of 50.79 μm in width×38.10 μm in height is further adjusted to have a pixel number of 1280 pixels×890 pixels.
(1-2) An image of the region of 50.79 μm in width×38.10 μm in height of the (1-1) is divided into 256 gradations, with a darkest part set to 0 and a brightest part set to 255.

The image of the region of 50.79 μm in width×38.10 μm in height of the (1-1) is divided into “10 in width×10 in height=100” small regions.

A standard deviation of the gradations is calculated for each of 64 small regions, excluding 36 small regions located on an outer periphery, out of the 100 small regions. A small region with a largest standard deviation of the gradations among the 64 small regions is specified.

Among the 64 small regions, “3 in width×3 in height=9” small regions centered around the small region with the largest standard deviation of the gradations are regarded as a convex portion of the low refractive index layer and a neighboring region thereof.

(1-3) The “convex portion and a neighboring region thereof” of the (1-2) is further divided into “10 in width×10 in height=100” fine regions.

A standard deviation of the gradations is calculated for each of the 100 fine regions. The gradations for the (1-3) use the 256 gradations of the (1-2). A fine region with a largest standard deviation of the gradations is specified among the 100 fine regions.

(1-4) An image of a region of 1270 nm in width×890 nm in height, centered around a center part of the fine region specified in the (1-3), is captured with a scanning electron microscope. A portion of the low refractive index layer within the image of the region of 1270 nm in width×890 nm in height is regarded as a convex portion of the low refractive index layer. A ratio of an area occupied by the spherical particles having an average particle size of 20 nm or more in the region of 1270 nm in width×890 nm in height is calculated.
(1-5) Operations described above in the (1-1) to (1-4) are performed at 20 positions on a surface of the first side of the optical laminate. An average of the ratios of the areas at 18 positions, excluding minimum and maximum values, is defined as the “average occupied area ratio of the spherical particles having an average particle size of 20 nm or more”.

### <Measurement 2>

(2-1) A vertical cross-section of the optical laminate is imaged with a scanning transmission electron microscope. An image is adjusted in such a manner that a region excluding a scale bar is 254 μm in width×178 μm in height.
(2-2) In the image of the region of 254 μm in width×178 μm in height of the (2-1), a position where the low refractive index layer is thickest is specified.
(2-3) An image of a region of 1270 nm in width×890 nm in height, centered around the position specified in the (2-2), is captured with a scanning transmission electron microscope. A portion of the low refractive index layer within the image of the region of 1270 nm in width×890 nm in height is regarded as a concave portion of the low refractive index layer. In the region of 1270 nm in width×890 nm in height, a film thickness of the low refractive index layer and a standard deviation of the film thickness of the low refractive index layer are calculated. The film thickness of the low refractive index layer is defined as an average value of film thicknesses at 25 positions. Similarly, the standard deviation of the film thickness of the low refractive index layer is defined as a standard deviation of the film thicknesses at 25 positions. The 25 positions are selected at 50 nm intervals within a range of the length of 1270 nm in width.
(2-4) Operations described above in the (2-1) to (2-3) are performed at 20 positions on the vertical cross-section of the optical laminate. An average of the film thicknesses and an average of the standard deviations of the film thicknesses at 18 positions, excluding minimum and maximum values, are defined respectively as the “average film thickness of the low refractive index layer” and the “average standard deviation of the film thickness of the low refractive index layer”.

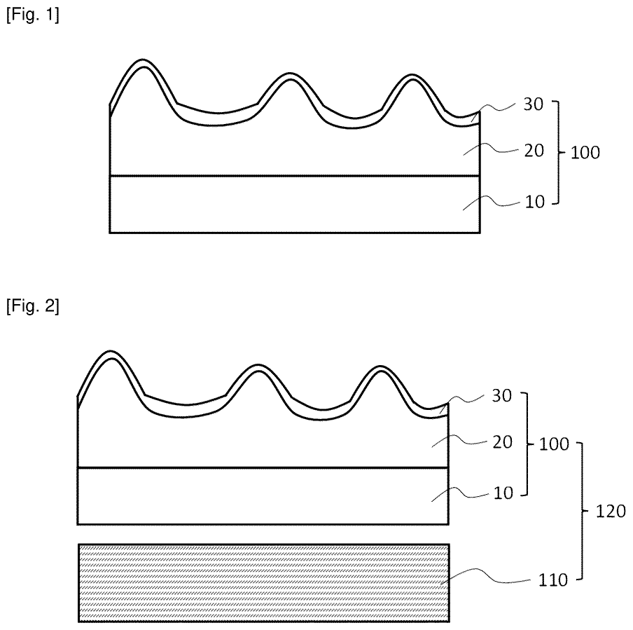

FIG. 1 is a schematical cross-sectional view of the cross-sectional shape of an optical laminate 100 of the present disclosure.

The optical laminate 100 of FIG. 1 comprises a first side having an uneven shape, and a second side on the opposite side to the first side. In FIG. 1, the upper side corresponds to the first side, and the lower side corresponds to the second side.

The optical laminate of FIG. 1 comprises a low refractive index layer 30, an anti-glare layer 20, and a substrate 10 in this order from the first side to the second side.

FIG. 1 is a schematical cross-sectional view. In other words, the scales of each layer constituting the optical laminate 100 and the uneven shape are schematic for ease of illustration, and differ from the actual scales. The same applies to FIG. 2.

The optical laminate of the present disclosure is not limited to the laminated structure shown in FIG. 1. For example, the optical laminate of the present disclosure may have a laminated structure not including the substrate. The optical laminate of the present disclosure may have a layer other than the substrate, the anti-glare layer, and the low refractive index layer.

### <First Side>

The optical laminate of the present disclosure comprises the first side. The first side has an uneven shape. Since the first side comprises the uneven shape, the optical laminate can more easily achieve good anti-glare properties.

In the optical laminate of the present disclosure, the surface of the low refractive index layer preferably corresponds to the first side.

### <Average Occupied Area Ratio>

The optical laminate of the present disclosure is required to have the “average occupied area ratio of spherical particles having an average particle size of 20 nm or more” calculated through Measurement 1 of 15.0% or more.

Measurement 1 includes steps (1-1) to (1-6).

The “average occupied area ratio of spherical particles having an average particle size of 20 nm or more” calculated through Measurement 1 means an average occupied area ratio in a position corresponding to a convex portion of the low refractive index layer.

### <<Step (1-1)>>

A surface on the first side of the optical laminate is imaged with a scanning electron microscope (SEM). An imaging area is adjusted in such a manner that a region excluding a scale bar is 50.79 μm in width×38.10 μm in height. The region of 50.79 μm in width×38.10 μm in height is further adjusted to have a pixel number of 1280 pixels×890 pixels.

The first side of the optical laminate has the uneven shape. This uneven shape has independent convex portions and concave portions around the convex portions. In the optical laminate with anti-glare properties, the size of a single convex portion generally has an area of 1.0 μm² or more and 50 μm² or less. Furthermore, in the optical laminate with anti-glare properties, the number of convex portions within the region of 50.79 μm in width×38.10 μm in height is generally 10 or more and 20 or less. Therefore, by setting the imaging area to 50.79 μm in width×38.10 μm in height in step (1-1), a sufficient number of convex portions can be included within the imaging area, and thus, measurement results of Measurement 1 can be stabilized.

In step (1-1), the acceleration voltage of the scanning electron microscope (SEM) is preferably 100 V or more and 30 kV or less.

An example of the scanning electron microscope (SEM) includes trade name SU-9000 available from Hitachi High-Technologies Corporation.

### <<Step (1-2)>>

An image of the region of 50.79 μm in width×38.10 μm in height of the (1-1) is divided into 256 gradations, with a darkest part set to 0 and a brightest part set to 255.

The image of the region of 50.79 μm in width×38.10 μm in height of the (1-1) is divided into “10 in width×10 in height=100” small regions.

A standard deviation of the gradations is calculated for each of 64 small regions, excluding 36 small regions located on an outer periphery, out of the 100 small regions. A small region with the largest standard deviation of the gradations among the 64 small regions is specified.

Among the 64 small regions, “3 in width×3 in height=9” small regions centered around the small region with the largest standard deviation of the gradations are regarded as a convex portion of the low refractive index layer and a neighboring region thereof.

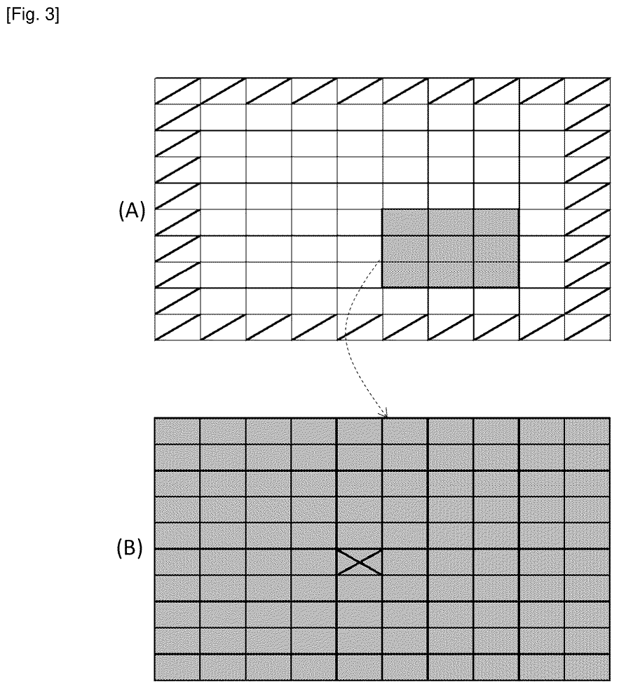

FIG. 3(A) is a diagram illustrating a state where the region of 50.79 μm in width×38.10 μm in height is divided into “10 in width×10 in height=100” small regions. In FIG. 3(A), regions with a single diagonal line indicate the 36 small regions located on the outer periphery. In FIG. 3(A), shaded regions indicate the “3 in width×3 in height=9” small regions centered around the small region with the largest standard deviation of the gradations.

When the first side is imaged using a scanning electron microscope, the spherical particles are imaged brightly, while the binder resin is imaged darkly. Therefore, it can be said that the standard deviation of the gradations in step (1-2) represents the standard deviation of the distribution state of the spherical particles.

The independent convex portions on the first side of the optical laminate are formed at positions corresponding to the convex portions of the anti-glare layer. The convex portions of the low refractive index layer are also formed at positions corresponding to the convex portions of the anti-glare layer. The low refractive index layer is formed by coating a low refractive index layer composition containing the binder resin and the spherical particles onto the anti-glare layer, and then drying the resultant. In the positions of the low refractive index layer that correspond to the convex portions of the anti-glare layer, the spherical particles easily flow down. In other words, the spherical particles easily flow off in the convex portions of the low refractive index layer. Therefore, the convex portions of the low refractive index layer tend to have a lower concentration of the spherical particles compared to the concave portions of the low refractive index layer. As described above, the spherical particles are imaged brightly, while the binder resin is imaged darkly. Therefore, the convex portions of the low refractive index layer show a larger standard deviation of the gradations compared to the concave portions of the low refractive index layer.

Accordingly, the “3 in width×3 in height=9” small regions, specified in step (1-2), centered around the small region with the largest standard deviation of the gradations can be regarded as the convex portion of the low refractive index layer and a neighboring region thereof.

The image of the region of 50.79 μm in width×38.10 μm in height is divided into “10 in width×10 in height=100” small regions in step (1-2) because the convex portions of the low refractive index layer can be easily identified thus through the division into the small regions.

### <<Step (1-3)>>

The “convex portion and a neighboring region thereof” of the (1-2) is further divided into “10 in width×10 in height=100” fine regions.

A standard deviation of the gradations is calculated for each of the 100 fine regions. The gradations for step (1-3) use the 256 gradations of the (1-2). A fine region with a largest standard deviation of the gradations is specified among the 100 fine regions.

Step (1-3) is a step of specifying a region around the center part of the convex portion by further dividing the “convex portion and a neighboring region thereof” of the (1-2).

FIG. 3(B) is a diagram illustrating a state where the “convex portion and a neighboring region thereof” of the (1-2) is further divided into “10 in width×10 in height=100” fine regions. In FIG. 3(B), a region with two diagonal lines indicates a fine region, among the 100 fine regions, that has the largest standard deviation of the gradations. In FIG. 3(B), the intersection of the two diagonal lines indicates the center part of the fine region with the largest standard deviation of the gradations. In the subsequent step (1-4), an image of a region of 1270 nm in width×890 nm in height, centered around the aforementioned center part, may be captured using a scanning electron microscope.

### <<Step (1-4)>>

An image of the region of 1270 nm in width×890 nm in height, centered around the center part of the fine region specified in the (1-3), is captured with a scanning electron microscope. A portion of the low refractive index layer within the image of the region of 1270 nm in width×890 nm in height is regarded as a convex portion of the low refractive index layer. A ratio of an area occupied by the spherical particles having an average particle size of 20 nm or more in the region of 1270 nm in width×890 nm in height is calculated.

In step (1-4), the ratio of the area occupied by the spherical particles having an average particle size of 20 nm or more within the region of 1270 nm in width×890 nm in height can be calculated, for example, using circular shape separation function of image analysis software. Particles determined as a circular shape by the circular shape separation function of image analysis software can be determined to be spherical particles.

An example of image analysis software equipped with circular shape separation function includes trade name “WinROOF version 6.6.0”, manufactured by MITANI CORPORATION.

### <<Step (1-5)>>

Operations described above in the (1-1) to (1-4) are performed at 20 positions on the surface of the first side of the optical laminate. An average of the ratios of the areas at 18 positions, excluding the minimum and maximum values, is defined as an “average occupied area ratio of spherical particles having an average particle size of 20 nm or more”.

The 20 positions selected for calculating the average occupied area ratio are selected from positions on the surface of the first side of the optical laminate that are free of defects.

Through Measurement 1 including steps (1-1) to (1-5) described above, the average occupied area ratio can be calculated. The average occupied area ratio calculated through Measurement 1 can be regarded as the “average occupied area ratio of spherical particles having an average particle size of 20 nm or more” in the convex portions of the low refractive index layer.

The average occupied area ratio of 15.0% or more, calculated through Measurement 1, means that the ratio occupied by the spherical particles having an average particle size of 20 nm or more is high in the convex portions of the low refractive index layer, and that the convex portions have a low refractive index. Therefore, by setting the average occupied area ratio to 15.0% or more, the anti-reflection properties of the optical laminate comprising the low refractive index layer laminated on the anti-glare layer can be easily improved.

Besides, by setting the average occupied area ratio to 15.0% or more, the low refractive index layer sufficiently covers the surface of the anti-glare layer, and thus, scratching of the anti-glare layer can be easily suppressed.

The average occupied area ratio is preferably 17.5% or more, more preferably 20.0% or more, and further preferably 22.5% or more.

When the average occupied area ratio is too high, the binder resin covering the spherical particles tends to become insufficient, which can easily lead to defects due to scratching. Therefore, the average occupied area ratio is preferably 90% or less, more preferably 85% or less, further preferably 80% or less, further preferably 50% or less, and still further preferably 35% or less.

Embodiments of the range of the average occupied area ratio include 15.0% or more and 90% or less, 15.0% or more and 85% or less, 15.0% or more and 80% or less, 15.0% or more and 50% or less, 15.0% or more and 35% or less, 17.5% or more and 90% or less, 17.5% or more and 85% or less, 17.5% or more and 80% or less, 17.5% or more and 50% or less, 17.5% or more and 35% or less, 20.0% or more and 90% or less, 20.0% or more and 85% or less, 20.0% or more and 80% or less, 20.0% or more and 50% or less, 20.0% or more and 35% or less, 22.5% or more and 90% or less, 22.5% or more and 85% or less, 22.5% or more and 80% or less, 22.5% or more and 50% or less, and 22.5% or more and 35% or less.

In order to easily achieve the average occupied area ratio of 15.0% or more, it is significant to prevent the spherical particles having an average particle size of 20 nm or more from flowing into the concave portions in forming the low refractive index layer on the anti-glare layer. Examples of the method for preventing the spherical particles having an average particle size of 20 nm or more from flowing into the concave portions include, as described below, “causing a fine particle linked structure to be contained in the low refractive index layer composition” and/or “utilizing a thermoplastic resin for the majority of a resin component of the low refractive index layer composition”.

### <Film Thickness>

The optical laminate of the present disclosure is required to have an “average film thickness of the low refractive index layer” and an “average standard deviation of a film thickness of the low refractive index layer” calculated through Measurement 2 respectively of 200 nm or less and 25.0 nm or less.

### Measurement 2 Includes Steps (2-1) to (2-4).

The “average film thickness of the low refractive index layer” and the “average standard deviation of a film thickness of the low refractive index layer” calculated through Measurement 2 mean an average film thickness and a standard deviation of a film thickness in positions corresponding to concave portions of the low refractive index layer.

### <<Step (2-1)>>

A vertical cross-section of the optical laminate is imaged with a scanning transmission electron microscope. An image is adjusted in such a manner that a region excluding a scale bar is 254 μm in width×178 μm in height.

The first side of the optical laminate has the uneven shape. This uneven shape has independent convex portions and concave portions around the convex portions. In the optical laminate having anti-glare properties, a distance between convex portions (approximately the width of the concave portion) is generally 2.0 μm or more and 20.0 μm or less. Therefore, by setting the imaging area to 254 μm in width×178 μm in height in step (2-1), concave portions can be included within the imaging area, and thus, the measurement results of Measurement 2 can be stabilized.

In step (2-1), the term “vertical cross-section of the optical laminate” means a cross-section perpendicular to the XY plane, assuming the first side of the optical laminate as the XY plane.

In step (2-1), the acceleration voltage of the scanning transmission electron microscope (STEM) is preferably 100 V or more and 30 kV or less.

An example of the scanning transmission electron microscope (STEM) includes trade name SU-9000 available from Hitachi High-Technologies Corporation.

In step (2-1), an image of the vertical cross-section of the optical laminate can be captured by preparing a sample with the vertical cross-section of the optical laminate exposed, and then performing imaging using the sample.

The sample can be prepared, for example, through the following steps (A1) to (A2):
(A1) After preparing a cut sample by cutting the optical laminate into an arbitrary size, the cut sample is embedded in a resin to prepare an embedded sample. The cut sample is, for example, a strip shape in a size of, for example, 10 mm in height×3 mm in width. An epoxy resin is preferably used as the embedding resin.

The embedded sample can be obtained, for example, by placing the cut sample inside a silicone embedding mold, pouring in the embedding resin thereinto, curing the embedding resin, and then removing the cut sample and the surrounding embedding resin from the silicone embedding mold. In the case of using an epoxy resin manufactured by Struers exemplified below, the aforementioned curing step is preferably carried out by leaving the sample at room temperature for 12 hours to cure. The embedded sample is in a block shape.

For example, a silicone embedding mold manufactured by Dosaka EM Co., Ltd. can be used. A silicone embedding mold may also be referred to as a silicone capsule. As the embedding epoxy resin, for example, a mixture of trade name “Epofix” and trade name “Epofix Hardener”, both manufactured by Struers, at a ratio of 10:1.2 can be used.

(A2) The block-shaped embedded sample is cut vertically to expose the cross-section of the optical laminate, and thus, a sample for cross-sectional image measurement is prepared. The sample for cross-sectional image measurement maintains the block shape. The embedded sample is preferably cut through the center of the cut sample. The embedded sample is preferably cut with a diamond knife.

An example of an apparatus for cutting the block-shaped embedded sample includes trade name “Ultra Microtome EM UC7” manufactured by Leica Microsystems. For cutting the block-shaped embedded sample, it is preferable to first make a rough cut (rough trimming) and then perform precise trimming under conditions of “SPEED: 1.00 mm/s” and “FEED: 70 nm”.

### <<Step (2-2)>>

In the image of the region of 254 μm in width×178 μm in height of the (2-1), a position where the low refractive index layer is thickest is specified.

Step (2-2) is a step of specifying the center of the concave portion of the low refractive index layer.

In forming the low refractive index layer on the anti-glare layer, the low refractive index layer composition tends to flow off the convex portion. The low refractive index layer composition that has flowed off the convex portion then flows into the concave portion. Therefore, in the low refractive index layer, the concave portion is thicker than the convex portion. Thus, the position where the low refractive index layer is thickest specified in step (2-2) can be regarded as the center of the concave portion of the low refractive index layer.

### <<Step (2-3)>>

An image of a region of 1270 nm in width×890 nm in height, centered around the position specified in the (2-2), is captured with a scanning transmission electron microscope.

A portion of the low refractive index layer within the image of the region of 1270 nm in width×890 nm in height is regarded as a concave portion of the low refractive index layer. In the region of 1270 nm in width×890 nm in height, a film thickness of the low refractive index layer and a standard deviation of the film thickness of the low refractive index layer are calculated. The film thickness of the low refractive index layer is defined as an average value of film thicknesses at 25 positions. Similarly, the standard deviation of the film thickness of the low refractive index layer is defined as a standard deviation of the film thicknesses at 25 positions. The 25 positions are selected at 50 nm intervals within a range of the length of 1270 nm in width.

At the 25 measurement points, the film thickness means a distance from an “interface between the low refractive index layer and a layer disposed below the low refractive index layer” to the “surface of the low refractive index layer”. The “surface of the low refractive index layer” means the surface of the low refractive index layer when no other layers are present on the low refractive index layer, and means an interface between the low refractive index layer and another layer when another layer is present on the low refractive index layer.

The measurement of the film thickness at 50 nm intervals in step (2-3) can be performed, for example, using image analysis software. An example of such image analysis software includes “ImageJ 1.53” available from public domain.

As described above, in the optical laminate having anti-glare properties, the distance between convex portions (approximately the width of the concave portion) is generally 2.0 μm or more and 20.0 μm or less. Therefore, the region of 1270 nm in width×890 nm in height centered around the position specified in the (2-2) can be regarded as the concave portion of the low refractive index layer.

### <<Step (2-4)>>

Operations described above in the (2-1) to (2-3) are performed at 20 positions on the vertical cross-section of the optical laminate. An average of the film thicknesses and an average of the standard deviations of the film thicknesses at 18 positions, excluding the minimum and maximum values, are defined respectively as the “average film thickness of the low refractive index layer” and the “average standard deviation of a film thickness of the low refractive index layer”.

By preparing 20 samples with an exposed vertical cross-section of the optical laminate, the film thicknesses and the standard deviation of the film thicknesses at 20 positions can be measured. These 20 samples with an exposed vertical cross-section of the optical laminate are selected from samples that have no defects in the cross-sections thereof.

Through Measurement 2 including steps (2-1) to (2-4) described above, the “average film thickness of the low refractive index layer” and the “average standard deviation of a film thickness of the low refractive index layer” can be calculated. The “average film thickness of the low refractive index layer” and the “average standard deviation of a film thickness of the low refractive index layer” calculated through Measurement 2 can be regarded as the “average film thickness of the low refractive index layer” and the “average standard deviation of a film thickness of the low refractive index layer” in the concave portion of the low refractive index layer.

The average film thickness of the low refractive index layer of 200 nm or less, calculated through Measurement 2, means that the film thickness of the low refractive index layer in the concave portion of the low refractive index layer is not too thick. Therefore, by setting the average film thickness of the low refractive index layer, obtained through Measurement 2, to 200 nm or less, the level of anti-reflection properties expected at the stage of coating film design can be more easily achieved, and the anti-reflection properties of the optical laminate can be easily improved.

Besides, by setting the average film thickness of the low refractive index layer, obtained through Measurement 2, to 200 nm or less, it is easier to suppress damage caused in a position of the low refractive index layer corresponding to the concave portion.

The average film thickness of the low refractive index layer, obtained through Measurement 2, is preferably 175 nm or less, more preferably 150 nm or less, and further preferably 135 nm or less.

When the average film thickness of the low refractive index layer, obtained through Measurement 2, is too small, the level of anti-reflection properties expected at the stage of coating film design is difficult to achieve. Therefore, the average film thickness of the low refractive index layer, obtained through Measurement 2, is preferably 70 nm or more, more preferably 80 nm or more, and further preferably 90 nm or more.

Embodiments of the range of the average film thickness of the low refractive index layer include 70 nm or more and 200 nm or less, 70 nm or more and 175 nm or less, 70 nm or more and 150 nm or less, 70 nm or more and 135 nm or less, 80 nm or more and 200 nm or less, 80 nm or more and 175 nm or less, 80 nm or more and 150 nm or less, 80 nm or more and 135 nm or less, 90 nm or more and 200 nm or less, 90 nm or more and 175 nm or less, 90 nm or more and 150 nm or less, and 90 nm or more and 135 nm or less.

That the average standard deviation of the film thickness of the low refractive index layer calculated through Measurement 2 is 25.0 nm or less means that the variation in the film thickness of the low refractive index layer is small among concave portions of the low refractive index layer. Therefore, by setting the average standard deviation of the film thickness of the low refractive index layer, obtained through Measurement 2, to 25.0 nm or less, it becomes easier to achieve the level of anti-reflection properties expected at the stage of coating film design, and to improve the anti-reflection properties of the optical laminate.

Besides, by setting the average standard deviation of the film thickness of the low refractive index layer, obtained through Measurement 2, to 25.0 nm or less, it is easier to suppress damage caused in a thick portion of the low refractive index layer.

The average standard deviation of the film thickness of the low refractive index layer calculated through Measurement 2 is preferably 22.5 nm or less, more preferably 20.0 nm or less, and further preferably 17.5 nm or less.

The lower limit of the average standard deviation of the film thickness of the low refractive index layer calculated through Measurement 2 is not especially limited, and is usually 1.0 nm or more.

Embodiments of the range of the average standard deviation of the film thickness of the low refractive index layer include 1.0 nm or more and 25.0 nm or less, 1.0 nm or more and 22.5 nm or less, 1.0 nm or more and 20.0 nm or less, and 1.0 nm or more and 17.5 nm or less.

In Measurement 2, in order to easily achieve the average film thickness of the low refractive index layer of 200 nm or less and the average standard deviation of the film thickness of the low refractive index layer of 25.0 nm or less, it is significant to prevent the low refractive index layer composition from easily flowing into the concave portions in forming the low refractive index layer on the anti-glare layer. It is also significant to prevent the low refractive index layer composition from entraining air in flowing into the concave portions, or to suppress uneven coating of the low refractive index layer.

In order to prevent the low refractive index layer composition from easily flowing into the concave portion, it is preferable “to cause a fine particle linked structure to be contained in the low refractive index layer composition” and/or “to utilize a thermoplastic resin for the majority of a resin component of the low refractive index layer composition”. Besides, in order to prevent the low refractive index layer composition from entraining air in flowing into the concave portions, it is preferable “to set the linked structure to a prescribed length”. Further, in order to suppress uneven coating of the low refractive index layer, it is preferable “to set the molecular weight of the thermoplastic resin to 200,000 or less”.

Herein, unless otherwise specified, Measurements 1 and 2, as well as other measurements for surface shape, optical characteristics, and the like, are conducted at a temperature of 23±5° C. and a relative humidity of 40% or more and 65% or less. Besides, the measurement is performed with a target sample exposed to the aforementioned atmosphere for 30 minutes or more and 60 minutes or less before starting each measurement.

In the optical laminate of the present disclosure, the “average occupied area ratio of spherical particles having an average particle size of 20 nm or more” at the position corresponding to the concave portion of the low refractive index layer is preferably 17.5% or more and 90% or less, more preferably 20% or more and 85% or less, and further preferably 22.5% or more and 80% or less.

In the optical laminate of the present disclosure, the “average film thickness of the low refractive index layer” at the position corresponding to the convex portion of the low refractive index layer is preferably 5 nm or more and 175 nm or less, more preferably 10 nm or more and 150 nm or less, and further preferably 20 nm or more and 135 nm or less.

In the optical laminate of the present disclosure, the “average standard deviation of a film thickness of the low refractive index layer” at the position corresponding to the convex portion of the low refractive index layer is preferably 25.0 nm or less, more preferably 22.5 nm or less, and further preferably 20.0 nm or less.

### <Laminated Structure>

The optical laminate of the present disclosure comprises a low refractive index layer and an anti-glare layer in this order, from the first side to the second side. The outermost surface on the first side of the optical laminate is preferably the low refractive index layer.

The optical laminate of the present disclosure may have a layer other than the low refractive index layer and the anti-glare layer. Examples of the layer other than the low refractive index layer and the anti-glare layer include a substrate, a high refractive index layer, an antistatic layer, and an adhesive layer.

### <<Substrate>>

The optical laminate preferably has a substrate for ease of production and ease of handling.

The substrate preferably has light transmittance, smoothness, heat resistance, and excellent mechanical strength. Examples of such a substrate include plastic films such as polyester, triacetyl cellulose (TAC), cellulose diacetate, cellulose acetate butyrate, polyamide, polyimide, polyether sulfone, polysulfone, polypropylene, polymethylpentene, polyvinyl chloride, polyvinyl acetal, polyether ketone, polymethyl methacrylate, polycarbonate, polyurethane, and amorphous olefin (Cyclo-Olefin-Polymer: COP). The substrate may be a laminate of two or more plastic films.

Among these plastic films, for the mechanical strength and the dimensional stability, a stretched polyester film is preferred, and a biaxially stretched polyester film is more preferred. Examples of the polyester film include a polyethylene terephthalate film, and a polyethylene naphthalate film. A TAC film and an acrylic film are preferable because light transmittance and optical isotropy can be easily improved. A COP film and a polyester film are preferable due to excellent weather resistance.

The thickness of the substrate is preferably 5 μm or more and 300 μm or less, more preferably 20 μm or more and 200 μm or less, and still more preferably 30 μm or more and 120 μm or less.

When it is desired to reduce the thickness of the optical laminate, the upper limit of the thickness of the substrate is preferably 100 μm or less, and more preferably 80 μm or less. When the substrate is a low moisture-permeable substrate such as polyester, COP, or acrylic, the upper limit of the thickness of the substrate for forming a thin film is preferably 60 μm or less, and more preferably 40 μm or less. Even in the case of a large screen, when the upper limit of the thickness of the substrate is within the aforementioned range, strain is less likely to occur, which is also preferable.

The thickness of the substrate can be measured with a film thickness measurement device. An example of the film thickness measurement device includes Digimatic standard outside micrometer (product number: MDC-25SX) available from Mitutoyo Corporation. As the thickness of the substrate, the average of the values measured at any ten points thereof may be the value described above.

Embodiments of the range of the thickness of the substrate include 5 μm or more and 300 μm or less, 5 μm or more and 200 μm or less, 5 μm or more and 120 μm or less, 5 μm or more and 80 μm or less, 5 μm or more and 60 μm or less, 5 μm or more and 40 μm or less, 20 m or more and 300 μm or less, 20 μm or more and 200 μm or less, 20 μm or more and 120 m or less, 20 μm or more and 80 μm or less, 20 μm or more and 60 μm or less, 20 μm or more and 40 μm or less, 30 μm or more and 300 μm or less, 30 μm or more and 200 μm or less, 30 μm or more and 120 μm or less, 30 μm or more and 80 μm or less, 30 μm or more and 60 μm or less, and 30 μm or more and 40 μm or less.

The substrate preferably has a total light transmittance in accordance with JIS K7361-1:1997 of 70% or more, more preferably 80% or more, and further preferably 85% or more.

The substrate preferably has a haze in accordance with JIS K7136:2000 of 10% or less, more preferably 5% or less, and further preferably 3% or less.

A surface of the substrate may be subjected to a physical treatment such as a corona discharge treatment, or a chemical treatment, to improve adhesiveness. Besides, the substrate may include an easily adhesive layer on the surface.

### <<Anti-Glare Layer>>

The anti-glare layer is a layer responsible for the center of the anti-glare properties.

The anti-glare layer can be formed, for example, by (A) a method using an embossing roll, (B) an etching treatment, (C) molding with a mold, or (D) formation of a coating film by coating. (C) molding with a mold is suitable for easily obtaining a stable surface shape, and (D) formation of a coating film by coating is suitable for productivity and compatibility with various products.

In employing the method (C), for example, the anti-glare layer can be formed by pouring a resin into a mold and then removing the molded resin from the mold. As the mold, one that is an inverse of the surface shape of the anti-glare layer is used. This type of mold can be produced, for example, through procedures (c1-1) to (c1-2) described below, or by a procedure (c2) described below.

(c1-1) A desired surface shape is created by simulation. Then, the simulated shape is inverted.

(c1-2) A metal surface is engraved with a laser beam, or the metal surface is processed by photolithography, so as to reflect the inverted shape, and thus, the mold is obtained.

(c2) A mold that is an inverse of the shape of the anti-glare layer prepared by the method (D) is obtained by a generally used electroforming method.

When the anti-glare layer is formed by the method (D), for example, the following methods (d1) and (d2) can be employed. The (d1) is more preferred because the surface shape can be more easily adjusted than in the (d2).

(d1) A method in which an anti-glare layer composition containing a binder resin and particles is applied and dried to form the anti-glare layer having unevenness due to the particles.

(d2) A method in which an anti-glare layer composition containing any resin and a resin having poor compatibility with the resin is applied to phase-separate the resins to form unevenness.

### —Thickness—

The thickness T of the anti-glare layer is preferably 2.0 μm or more and 10.0 μm or less, more preferably 3.0 μm or more and 8.0 μm or less, and still more preferably 4.0 μm or more and 6.0 μm or less, in order to achieve a good balance among curl suppression, mechanical strength, hardness, and toughness.

The thickness of the anti-glare layer can be calculated by selecting 20 arbitrary points in a cross-sectional photograph of the optical laminate taken with a scanning transmission electron microscope and averaging the values. It is preferable that the acceleration voltage of the STEM is 10 kV or more and 30 kV or less, and the magnification of the STEM is 1000 times or more and 7000 times or less.

Embodiments of a range of the thickness of the anti-glare layer include 2.0 μm or more and 10.0 μm or less, 2.0 μm or more and 8.0 μm or less, 2.0 μm or more and 6.0 μm or less, 3.0 μm or more and 10.0 μm or less, 3.0 μm or more and 8.0 μm or less, 3.0 μm or more and 6.0 μm or less, 4.0 μm or more and 10.0 μm or less, 4.0 μm or more and 8.0 μm or less, and 4.0 μm or more and 6.0 μm or less.

### —Components—

The anti-glare layer preferably mainly contains a resin component. It is preferable that the anti-glare layer further optionally contain particles such as organic particles and inorganic particles, nanometer-sized fine particles, and additives such as a refractive index adjuster, an anti-static agent, a leveling agent, an ultraviolet absorber, a light stabilizer, an antioxidant, a viscosity modifier, and a thermal polymerization initiator.

The anti-glare layer preferably contains a binder resin and particles.

### —Particles—

The particles have an average particle size of preferably 1.0 μm or more, more preferably 1.5 μm or more, and further preferably 2.0 μm or more.

When the average particle size is 1.0 μm or more, the anti-glare properties can be easily improved. In addition, when the average particle size is 1.0 μm or more, the anti-reflection properties of the optical laminate easily degrade, but the optical laminate of the present disclosure can be easily improved in the anti-reflection properties because the “average occupied area ratio of spherical particles having an average particle size of 20 nm or more”, the “average film thickness of the low refractive index layer”, and the “average standard deviation of a film thickness of the low refractive index layer” are specified to the prescribed ranges.

The particles have an average particle size of preferably 10.0 μm or less, more preferably 9.5 μm or less, and further preferably 9.0 μm or less.

When the average particle size is 10.0 μm or less, scratch resistance of the optical laminate can be easily improved. In addition, when the average particle size is 10.0 μm or less, the “average occupied area ratio of spherical particles having an average particle size of 20 nm or more”, the “average film thickness of the low refractive index layer”, and the “average standard deviation of a film thickness of the low refractive index layer” can be easily set to fall in the above-described ranges.

Herein, an average particle size means a value obtained as a volume-average particle size d50 by a laser diffraction method.

Embodiments of the range of the average particle size of the particles include 1.0 μm or more and 10.0 μm or less, 1.0 μm or more and 9.5 μm or less, 1.0 μm or more and 9.0 μm or less, 1.5 μm or more and 10.0 μm or less, 1.5 μm or more and 9.5 μm or less, 1.5 μm or more and 9.0 μm or less, 2.0 μm or more and 10.0 μm or less, 2.0 μm or more and 9.5 μm or less, and 2.0 μm or more and 9.0 μm or less.

Examples of the inorganic particles include silica, alumina, zirconia, and titania, and silica is preferred.

Examples of the organic particles include particles containing one or more resins selected from the group consisting of polymethyl methacrylate, a polyacryl-styrene copolymer, a melamine resin, polycarbonate, polystyrene, polyvinyl chloride, a benzoguanamine-melamine-formaldehyde condensate, silicone, a fluorine-based resin, and a polyester-based resin.

Regarding the relationship between the thickness T of the anti-glare layer and the average particle size d50 of the particles, a value d50/T is preferably 0.55 or more and 1.00 or less, more preferably 0.60 or more and 0.95 or less, and further preferably 0.70 or more and 0.90 or less. Other embodiments of the range of the d50/T include 0.55 or more and 0.95 or less, 0.55 or more and 0.90 or less, 0.60 or more and 1.00 or less, 0.60 or more and 0.90 or less, 0.70 or more and 1.00 or less, and 0.70 or more and 0.95 or less.

When the d50/T is 0.55 or more, the anti-glare properties can be easily improved. When the d50/T is 1.00 or less, the scratch resistance of the optical laminate can be easily improved. In addition, when the d50/T is 1.00 or less, the “average occupied area ratio of spherical particles having an average particle size of 20 nm or more”, the “average film thickness of the low refractive index layer”, and the “average standard deviation of a film thickness of the low refractive index layer” can be easily set to fall in the above-described ranges.

The content of particles is preferably 10 parts by mass or more and 200 parts by mass or less, more preferably 15 parts by mass or more and 170 parts by mass or less, and still more preferably 20 parts by mass or more and 150 parts by mass or less based on 100 parts by mass of the binder resin. Other embodiments of the range of the content of the particles with respect to 100 parts by mass of the binder resin include 10 parts by mass or more and 170 parts by mass or less, 10 parts by mass or more and 150 parts by mass or less, 15 parts by mass or more and 200 parts by mass or less, 15 parts by mass or more and 150 parts by mass or less, 20 parts by mass or more and 200 parts by mass or less, and 20 parts by mass or more and 170 parts by mass or less.

When the content of the particles is 10 parts by mass or more, the anti-glare properties can be easily improved. When the content of the particles is 200 parts by mass or less, the scratch resistance of the optical laminate can be easily improved. When the content of the particles is 200 parts by mass or less, the “average occupied area ratio of spherical particles having an average particle size of 20 nm or more”, the “average film thickness of the low refractive index layer”, and the “average standard deviation of a film thickness of the low refractive index layer” can be easily set to fall in the above-described ranges.

### —Inorganic Fine Particles—

The anti-glare layer may further contain inorganic fine particles in addition to the binder resin and the particles. In the present specification, the inorganic fine particles and the aforementioned particles can be distinguished with the average particle size.

By containing the inorganic fine particles in the anti-glare layer, the difference between the refractive index of the particles and the refractive index of the composition other than the particles of the anti-glare layer becomes small, and the internal haze can be easily reduced.

Examples of the inorganic fine particles include fine particles made of silica, alumina, zirconia, and titania. Among these, silica is preferable since it easily suppresses the generation of internal haze.

The average particle size of the inorganic fine particles is preferably 1 nm or more and 200 nm or less, more preferably 2 nm or more and 100 nm or less, and still more preferably 5 nm or more and 50 nm or less. Other embodiments of the range of the average particle size of the inorganic fine particles include 1 nm or more and 100 nm or less, 1 nm or more and 50 nm or less, 2 nm or more and 200 nm or less, 2 nm or more and 50 nm or less, 5 nm or more and 200 nm or less, and 5 nm or more and 100 nm or less.

### —Binder Resin—

In order to easily improve the scratch resistance, the binder resin preferably contains a cured product of a curable resin composition such as a cured product of a thermosetting resin composition or a cured product of an ionizing radiation-curable resin composition, and more preferably contains a cured product of an ionizing radiation-curable resin composition.

The binder resin may contain a thermoplastic resin as long as the effects of the present disclosure are not impaired.

For easily improving the scratch resistance, a ratio of the cured product of the curable resin composition to the total amount of the binder resin is preferably 80% by mass or more, more preferably 90% by mass or more, and further preferably 100% by mass.

The thermosetting resin composition is a composition containing at least a thermosetting resin, and is a resin composition that is cured by heating.

Examples of thermosetting resins include acrylic resins, urethane resins, phenol resins, urea melamine resins, epoxy resins, unsaturated polyester resins, and silicone resins. If necessary, a curing agent is added to these curable resins in the thermosetting resin composition.

The ionizing radiation-curable resin composition is a composition containing a compound having an ionizing radiation-curable functional group (hereinafter also referred to as an “ionizing radiation-curable compound”). Examples of the ionizing radiation-curable functional group include ethylenically unsaturated bond groups such as a (meth)acryloyl group, a vinyl group, and an allyl group; an epoxy group; and an oxetanyl group. The ionizing radiation-curable compound is preferably a compound having an ethylenically unsaturated bond group, more preferably a compound having two or more ethylenically unsaturated bond groups, and in particular, still more preferably a polyfunctional (meth)acrylate-based compound having two or more ethylenically unsaturated bond groups. Both monomers and oligomers can be used as polyfunctional (meth)acrylate-based compounds.

The ionizing radiation means an electromagnetic wave or a charged particle beam having an energy quantum capable of polymerizing or crosslinking a molecule, and an ultraviolet ray (UV) or an electron beam (EB) is usually used, but an electromagnetic wave such as an X-ray or a γ-ray, or a charged particle beam such as an (α-ray or an ion beam can also be used.

Among the polyfunctional (meth)acrylate-based compounds, examples of the bifunctional (meth)acrylate-based monomer include ethylene glycol di(meth)acrylate, bisphenol A tetraethoxy diacrylate, bisphenol A tetrapropoxy diacrylate, and 1,6-hexanediol diacrylate.

Examples of the (meth)acrylate-based monomer having three or more functional groups include trimethylolpropane tri(meth)acrylate, pentaerythritol tri(meth)acrylate, pentaerythritol tetra(meth)acrylate, dipentaerythritol hexa(meth)acrylate, dipentaerythritol tetra(meth)acrylate, and isocyanuric acid-modified tri(meth)acrylate.

The (meth)acrylate-based monomer may be a monomer in which a part of the molecular skeleton is modified. For example, a monomer in which a part of the molecular skeleton is modified with ethylene oxide, propylene oxide, caprolactone, isocyanuric acid, alkyl, cyclic alkyl, aromatic, bisphenol, or the like can also be used as the (meth)acrylate-based monomer.

Examples of polyfunctional (meth)acrylate-based oligomers include acrylate-based polymers such as urethane (meth)acrylate, epoxy (meth)acrylate, polyester (meth)acrylate, and polyether (meth)acrylate.

Urethane (meth)acrylate is obtained, for example, by reacting polyhydric alcohol and organic diisocyanate with hydroxy (meth)acrylate.

Preferred epoxy (meth)acrylates are (meth)acrylates obtained by reacting a trifunctional or more aromatic epoxy resin, alicyclic epoxy resin, or aliphatic epoxy resin with a (meth)acrylic acid, (meth)acrylates obtained by reacting a bifunctional or more aromatic epoxy resin, alicyclic epoxy resin, or aliphatic epoxy resin with a polybasic acid and (meth)acrylic acid, and (meth)acrylates obtained by reacting a bifunctional or more aromatic epoxy resin, alicyclic epoxy resin, or aliphatic epoxy resin with phenol and (meth)acrylic acid.

The weight-average molecular weight of the polyfunctional (meth)acrylate-based oligomer is preferably 500 or more and 3000 or less, and more preferably 700 or more and 2500 or less. Other embodiments of the range of the weight-average molecular weight include 500 or more and 2500 or less, and 700 or more and 3000 or less.

In the present specification, the weight-average molecular weight is the average molecular weight measured by GPC analysis and converted to standard polystyrene.

For the purpose of adjusting the viscosity of the anti-glare layer composition or the like, a monofunctional (meth)acrylate may be used in combination as the ionizing radiation-curable compound. Examples of the monofunctional (meth)acrylate include methyl (meth)acrylate, ethyl (meth)acrylate, propyl (meth)acrylate, butyl (meth)acrylate, pentyl (meth)acrylate, hexyl (meth)acrylate, cyclohexyl (meth)acrylate, 2-ethylhexyl (meth)acrylate, lauryl (meth)acrylate, stearyl (meth)acrylate, and isobornyl (meth)acrylate.

The ionizing radiation-curable compounds may be used singly or in combination of two or more.

When the ionizing radiation-curable compound is an ultraviolet-curable compound, the ionizing radiation-curable composition preferably contains an additive such as a photopolymerization initiator or a photopolymerization accelerator.

Examples of the photopolymerization initiator include one or more selected from the group consisting of acetophenone, benzophenone, α-hydroxyalkylphenone, Michler's ketone, benzoin, benzyl dimethyl ketal, benzoyl benzoate, α-acyloxime ester, thioxanthones, and the like.

The photopolymerization accelerator can reduce polymerization inhibition caused by air during curing and increase the curing rate. Examples of the accelerator include p-dimethylaminobenzoic acid isoamyl ester, p-dimethylaminobenzoic acid ethyl ester, and the like.

The anti-glare layer may contain an additive such as a leveling agent or an antioxidant.

The anti-glare layer can be formed, for example, by coating an anti-glare layer composition containing components constituting the anti-glare layer onto the substrate, and then drying and curing the resultant if necessary.

### <<Low Refractive Index Layer>>

The low refractive index layer is preferably positioned on the outermost surface of the first side.

The low refractive index layer contains a binder resin and spherical particles having an average particle size of 20 nm or more. The spherical particles having an average particle size of 20 nm or more are preferably hollow particles.

The low refractive index layer can be formed by coating a low refractive index layer composition containing the binder resin and the spherical particles having an average particle size of 20 nm or more onto the anti-glare layer, and then drying and curing the resultant if necessary.

The lower limit of the refractive index of the low refractive index layer is preferably 1.10 or more, more preferably 1.20 or more, more preferably 1.26 or more, more preferably 1.28 or more, and more preferably 1.30 or more, and the upper limit thereof is preferably 1.48 or less, more preferably 1.45 or less, more preferably 1.40 or less, more preferably 1.38 or less, and more preferably 1.32 or less.

Herein, the refractive index is defined as a value at a wavelength of 550 nm.

Embodiments of the range of the refractive index of the low refractive index layer include 1.10 or more and 1.48 or less, 1.10 or more and 1.45 or less, 1.10 or more and 1.40 or less, 1.10 or more and 1.38 or less, 1.10 or more and 1.32 or less, 1.20 or more and 1.48 or less, 1.20 or more and 1.45 or less, 1.20 or more and 1.40 or less, 1.20 or more and 1.38 or less, 1.20 or more and 1.32 or less, 1.26 or more and 1.48 or less, 1.26 or more and 1.45 or less, 1.26 or more and 1.40 or less, 1.26 or more and 1.38 or less, 1.26 or more and 1.32 or less, 1.28 or more and 1.48 or less, 1.28 or more and 1.45 or less, 1.28 or more and 1.40 or less, 1.28 or more and 1.38 or less, 1.28 or more and 1.32 or less, 1.30 or more and 1.48 or less, 1.30 or more and 1.45 or less, 1.30 or more and 1.40 or less, 1.30 or more and 1.38 or less, and 1.30 or more and 1.32 or less.

—Spherical Particle with Average Particle Size of 20 nm or More—

The spherical particles having an average particle size of 20 nm or more are preferably hollow particles for easily improving the anti-reflection properties by lowering the refractive index of the low refractive index layer.

The spherical particles having an average particle size of 20 nm or more can be made of any of inorganic compounds such as silica and magnesium fluoride, and organic compounds, and silica is preferred for achieving a low refractive index and strength thereof. In other words, the spherical particles having an average particle size of 20 nm or more are preferably hollow silica particles.

The average particle size of the spherical particles having an average particle size of 20 nm or more is preferably 35 nm or more and 100 nm or less, more preferably 40 nm or more and 90 nm or less, and further preferably 50 nm or more and 80 nm or less. Other embodiments of the range of the average particle size of the spherical particles include 35 nm or more and 90 nm or less, 35 nm or more and 80 nm or less, 40 nm or more and 100 nm or less, 40 nm or more and 80 nm or less, 50 nm or more and 100 nm or less, and 50 nm or more and 90 nm or less.

A content of the spherical particles having an average particle size of 20 nm or more is preferably 50 parts by mass or more, and more preferably 100 parts by mass or more based on 100 parts by mass of the binder resin for easily improving the anti-reflection properties of the optical laminate.

On the other hand, when the content of the spherical particles having an average particle size of 20 nm or more is too high, the particles are not properly bound, and hence the scratch resistance of the optical laminate tends to decrease. Therefore, the content of the spherical particles having an average particle size of 20 nm or more is preferably 300 parts by mass or less, and more preferably 250 parts by mass or less based on 100 parts by mass of the binder resin.

Embodiments of the range of the content of the spherical particles with respect to 100 parts by mass of the binder resin include 50 parts by mass or more and 300 parts by mass or less, 50 parts by mass or more and 250 parts by mass or less, 100 parts by mass or more and 300 parts by mass or less, and 100 parts by mass or more and 250 parts by mass or less.

For easily achieving the “average occupied area ratio of spherical particles having an average particle size of 20 nm or more”, the “average film thickness of the low refractive index layer”, and the “average standard deviation of a film thickness of the low refractive index layer” falling respectively in the above-described ranges, the low refractive index layer preferably employs either of the following embodiments (1) and (2):
(1) the low refractive index layer contains a fine particle linked structure; and
(2) the low refractive index layer contains a thermoplastic resin as the binder resin, and contains the thermoplastic resin in an amount of 60% by mass or more to the total amount of the binder resin.

### —Fine Particle Linked Structure—

The fine particle linked structure is longer than the spherical particles, and hence is considered to hook the spherical particles having an average particle size of 20 nm or more in the low refractive index layer composition. For this reason, when the fine particle linked structure is contained, the spherical particles having an average particle size of 20 nm or more are difficult to flow off from the convex portions of the low refractive index layer, therefore, it is considered that the “‘average occupied area ratio of spherical particles having an average particle size of 20 nm or more” and the like within the aforementioned range can be easily achieved. Besides, when the fine particle linked structure is contained, the viscosity of the low refractive index layer composition increases, the low refractive index layer composition is difficult to flow off from the convex portions of the low refractive index layer, and therefore, it is considered that the “‘average occupied area ratio of spherical particles having an average particle size of 20 nm or more” and the like within the aforementioned range can be easily achieved.

To cause the function of the fine particle linked structure described above to exhibit more easily, the fine particle linked structure has a major axis of preferably 20 nm or more, more preferably 30 nm or more, and further preferably 35 nm or more.

On the other hand, when the major axis of the fine particle linked structure is too long, the low refractive index layer composition that contains the fine particle linked structure tends to cause, in flowing into the concave portions, a phenomenon like dam collapse. As a result, the amount of the composition flowing down may increase, or the composition may flow down vigorously. When a large amount of the low refractive index layer composition flows down, the film thickness in the concave portions of the low refractive index layer tends to increase. When the low refractive index layer composition flows down vigorously, air tends to be easily entrained, and the film thickness in the concave portions of the low refractive index layer tends to increase. Accordingly, the major axis of the fine particle linked structure is preferably 200 nm or less, more preferably 150 nm or less, and further preferably 100 nm or less.

Herein, the major axis of the fine particle linked structure means the maximum length between any two points in the linked structure.

Besides, herein, the major axis of the fine particle linked structure means the average of 18 major axes, excluding the minimum and maximum values, of 20 linked structures. The major axis of each linked structure can be measured by preparing a sample having an exposed horizontal cross-section of the optical laminate, imaging the prepared sample with a scanning transmission electron microscope, and performing the following procedures (3-1) to (3-2) based on the thus obtained image. The term “horizontal cross-section of the optical laminate” means a cross-section parallel to the XY plane, assuming that the first side of the optical laminate corresponds to the XY plane.

(3-1) The image captured with a scanning transmission electron microscope is adjusted in such a manner that a region excluding a scale bar is 633 nm in width×433 nm in height.

(3-2) From the image obtained in the (3-1), 20 fine particle linked structures are extracted, and the major axis of each linked structure is measured. The average of 18 major axes, excluding the minimum and maximum values, of the 20 linked structures are calculated.

The sample having an exposed horizontal cross-section of the optical laminate can be prepared, for example, through the following (B1) to (B2).

(B1) After preparing a cut sample by cutting the optical laminate into an arbitrary size, the cut sample is embedded in a resin to prepare an embedded sample.

(B2) The embedded sample is cut horizontally to prepare a sample for cross-sectional image measurement having an exposed horizontal cross-section of the optical laminate.

The fine particle linked structure preferably has a structure in which fine particles are connected in a bead-like manner. The structure in which fine particles are connected in a bead-like manner differs from generally used aggregates in which fine particles are agglomerated into a spherical or elliptical shape. Examples of the structure in which fine particles are connected in a bead-like manner include a structure in which fine particles are continuously linked in a straight or curved line, and a structure in which a plurality of such straight and/or curved structures are intertwined.

The fine particles constituting the linked structure are preferably solid particles.

The material of the fine particles constituting the linked structure is preferably an inorganic compound such as a silica-based compound or magnesium fluoride, and a silica-based compound is preferred for achieving a low refractive index and strength. In other words, the fine particles constituting the linked structure are preferably solid silica-based particles.

As the silica-based compound, compounds containing a hydrolysis condensate of tetrafunctional silane, trifunctional silane, difunctional silane, or monofunctional silane are preferred, and these compounds may be used singly or in combination of two or more. From the viewpoints of a low refractive index and strength, as the silica-based compound, a compound containing a hydrolysis condensate of tetrafunctional silane or trifunctional silane is more preferable.

The fine particles constituting the linked structure has an average primary particle size of preferably 1 nm or more and 30 nm or less, more preferably 5 nm or more and 20 nm or less, and further preferably 10 nm or more and 15 nm or less. Other embodiments of the range of the average primary particle size of the fine particles include 1 nm or more and 20 nm or less, 1 nm or more and 15 nm or less, 5 nm or more and 30 nm or less, 5 nm or more and 15 nm or less, 10 nm or more and 30 nm or less, and 10 nm or more and 20 nm or less.

A content of the fine particle linked structure is preferably 10 parts by mass or more and 50 parts by mass or less, more preferably 12.5 parts by mass or more and 45 parts by mass or less, and further preferably 15 parts by mass or more and 40 parts by mass or less based on 100 parts by mass of the binder resin. Other embodiments of the range the content of the linked structure with respect to 100 parts by mass of the binder resin include 10 parts by mass or more and 45 parts by mass or less, 10 parts by mass or more and 40 parts by mass or less, 12.5 parts by mass or more and 50 parts by mass or less, 12.5 parts by mass or more and 40 parts by mass or less, 15 parts by mass or more and 50 parts by mass or less, and 15 parts by mass or more and 45 parts by mass or less.

When the content of the fine particle linked structure is 10 parts by mass or more, the effect of including the fine particle linked structure can be easily exhibited. When the content of the fine particle linked structure is 50 parts by mass or less, decrease in the occupied area ratio of the spherical particles having an average particle size of 20 nm or more can be easily suppressed.

The fine particle linked structure can be produced, for example, by a method described in paragraph 0018 of JP 2010-143784 A. In the method, as humid heat reaction time is longer, the major axis of the fine particle linked structure tends to increase.

### —Binder Resin—

In the embodiment (1) described above, the binder resin of the low refractive index layer preferably contains a cured product of a curable resin composition such as a cured product of a thermosetting resin composition or a cured product of an ionizing radiation-curable resin composition, and more preferably contains a cured product of an ionizing radiation-curable resin composition for improving the scratch resistance. Besides, the binder resin may contain F or Si atoms. In the embodiment (1) described above, the binder resin may contain a thermoplastic resin as long as the effects of the present disclosure are not impaired.

Examples of the cured product of a curable resin composition for the low refractive index layer can be the same as those exemplified regarding the cured product of the curable resin composition for the anti-glare layer.

In the embodiment (1) described above, a ratio of the cured product of the curable resin composition to the total amount of the binder resin in the low refractive index layer is preferably 80% by mass or more, more preferably 90% by mass or more, and further preferably 97% by mass or more.

In the embodiment (2) described above, the low refractive index layer contains a thermoplastic resin as the binder resin, and contains the thermoplastic resin in an amount of 60% by mass or more to the total amount of the binder resin. When the thermoplastic resin is contained in an amount of 60% by mass or more to the total amount of the binder resin, the viscosity of the low refractive index layer composition increases, and therefore, the low refractive index layer composition is unlikely to flow off the convex portions of the low refractive index layer, and thus, it is considered that the “average occupied area ratio of spherical particles having an average particle size of 20 nm or more” and the like can be easily set to fall in the aforementioned ranges.

In the embodiment (2) described above, the content of the thermoplastic resin is more preferably 75% by mass or more, and further preferably 85% by mass or more to the total amount of the binder resin. In the embodiment (2) described above, the binder resin may contain F or Si atoms.

In the embodiment (2) described above, when the content of the thermoplastic resin is too high, the scratch resistance of the optical laminate tends to decrease. Besides, when the content of the thermoplastic resin is too high, ink viscosity becomes excessively high, and this leads to an uneven arrangement of the spherical particles, resulting in easily increasing the reflectance.

Therefore, in the embodiment (2) described above, the content of the thermoplastic resin is preferably 95% by mass or less to the total amount of the binder resin.

Examples of the thermoplastic resin include polystyrene-based resins, polyolefin-based resins, ABS resins (including heat-resistant ABS resins), AS resins, AN resins, polyphenylene oxide-based resins, polycarbonate-based resins, polyacetal-based resins, acrylic resins, polyethylene terephthalate-based resins, polybutylene terephthalate-based resins, polysulfone-based resins, and polyphenylene sulfide-based resins, and acrylic resin is preferable from the viewpoints of transparency.

The weight-average molecular weight of the thermoplastic resin is preferably 20,000 or more and 200,000 or less, more preferably 30,000 or more and 150,000 or less, and still more preferably 50,000 or more and 100,000 or less.

When the weight-average molecular weight is 20000 or more, the effect due to the thermoplastic resin can be more easily exhibited. When the weight-average molecular weight is 200000 or less, arrangement of the spherical particles can be easily made uniform, resulting in easily reducing the reflectance.

In the embodiment (2) described above, a cured product of an ionizing radiation-curable resin composition is preferably contained, in addition to the thermoplastic resin, as the binder resin.

In the embodiment (2) described above, a mass ratio between the thermoplastic resin and the cured product of the ionizing radiation-curable resin composition is preferably 60:40 to 99:1, and more preferably 70:30 to 95:5.

When the cured product of the ionizing radiation-curable resin composition is contained in addition to the thermoplastic resin, a decrease in scratch resistance can be easily suppressed while the aforementioned effect due to the thermoplastic resin is exhibited.

The low refractive index layer may contain additives such as a leveling agent, an anti-fouling agent, and an antioxidant.

### <<High Refractive Index Layer>>

The optical laminate of the present disclosure may include a high refractive index layer between the anti-glare layer and the low refractive index layer for further improving the anti-reflection properties.

The lower limit of the refractive index of the high refractive index layer is preferably 1.53 or more, more preferably 1.54 or more, more preferably 1.55 or more, more preferably 1.56 or more, and the upper limit thereof is preferably 1.85 or less, more preferably 1.80 or less, more preferably 1.75 or less, and more preferably 1.70 or less.

Embodiments of the range of the refractive index of the high refractive index layer include 1.53 or more and 1.85 or less, 1.53 or more and 1.80 or less, 1.53 or more and 1.75 or less, 1.53 or more and 1.70 or less, 1.54 or more and 1.85 or less, 1.54 or more and 1.80 or less, 1.54 or more and 1.75 or less, 1.54 or more and 1.70 or less, 1.55 or more and 1.85 or less, 1.55 or more and 1.80 or less, 1.55 or more and 1.75 or less, 1.55 or more and 1.70 or less, 1.56 or more and 1.85 or less, 1.56 or more and 1.80 or less, 1.56 or more and 1.75 or less, and 1.56 or more and 1.70 or less.

The upper limit of a film thickness of the high refractive index layer is preferably 200 nm or less, more preferably 180 nm or less, and further preferably 150 nm or less, and the lower limit is preferably 50 nm or more, and more preferably 70 nm or more.

Embodiments of the range of the film thickness of the high refractive index layer include 50 nm or more and 200 nm or less, 50 nm or more and 180 nm or less, 50 nm or more and 150 nm or less, 70 nm or more and 200 nm or less, 70 nm or more and 180 nm or less, and 70 nm or more and 150 nm or less.

The high refractive index layer contains, for example, a binder resin and high refractive index particles.

Examples of the binder resin can be the same as those exemplified for the binder resin of the low refractive index layer.

Examples of the high refractive index particles include antimony pentoxide, zinc oxide, titanium oxide, cerium oxide, tin-doped indium oxide, antimony-doped tin oxide, yttrium oxide, and zirconium oxide.

An average primary particle size of the high refractive index particles is preferably 2 nm or more, more preferably 5 nm or more, and further preferably 10 nm or more. Besides, from the viewpoints of whitening suppression and transparency, the average primary particle size of the high refractive index particles is preferably 200 nm or less, more preferably 100 nm or less, further preferably 80 nm or less, further preferably 60 nm or less, and still further preferably 30 nm or less.

Embodiments of the range of the average primary particle size of the high refractive index particles include 2 nm or more and 200 nm or less, 2 nm or more and 100 nm or less, 2 nm or more and 80 nm or less, 2 nm or more and 60 nm or less, 2 nm or more and 30 nm or less, 5 nm or more and 200 nm or less, 5 nm or more and 100 nm or less, 5 nm or more and 80 nm or less, 5 nm or more and 60 nm or less, 5 nm or more and 30 nm or less, 10 nm or more and 200 nm or less, 10 nm or more and 100 nm or less, 10 nm or more and 80 nm or less, 10 nm or more and 60 nm or less, and 10 nm or more and 30 nm or less.

A content of the high refractive index particles may be a content that ensures the refractive index of the high refractive index layer falls within the above-described range.

### <Surface Shape>

It is preferable that the first side of the optical laminate have an uneven shape, and have a three-dimensional arithmetic mean height Sa of 0.30 μm or more. When the first side has an uneven shape, and has the Sa of 0.30 μm or more, the anti-glare properties of the optical laminate can be easily improved.

The first side has the Sa of more preferably 0.35 μm or more, further preferably 0.40 μm or more, and still further preferably 0.45 μm or more.

When the Sa of the first side is too large, the scratch resistance of the optical laminate may decrease. Therefore, the Sa of the first side is preferably 1.00 μm or less, more preferably 0.80 μm or less, and further preferably 0.70 μm or less.

Embodiments of the range of the Sa of the first side include 0.30 μm or more and 1.00 μm or less, 0.30 μm or more and 0.80 μm or less, 0.30 μm or more and 0.70 μm or less, 0.35 m or more and 1.00 μm or less, 0.35 μm or more and 0.80 μm or less, 0.35 μm or more and 0.70 μm or less, 0.40 μm or more and 1.00 μm or less, 0.40 μm or more and 0.80 μm or less, 0.40 μm or more and 0.70 μm or less, 0.45 μm or more and 1.00 μm or less, 0.45 μm or more and 0.80 μm or less, and 0.45 μm or more and 0.70 μm or less.

Herein, the three-dimensional arithmetic mean roughness Sa is an extension, to three dimensions, of a two-dimensional roughness parameter Ra, described in JIS B0601: 1994, and is calculated by the following expression, assuming that orthogonal coordinate axes X and Y are set on a reference plane, that a roughness surface is defined as Z (x,y), and that the dimension of the reference plane is defined as Lx, Ly. In the following expression, A=Lx×Ly.

$$Sa = \frac{1}{A} {\int }_{O}^{Lx} {\int }_{O}^{Ly} \vert Z ( x , y ) \vert dxdy \qquad [ Expression 1 ]$$

The first side of the optical laminate preferably has a three-dimensional mean peak spacing Smp of preferably 1.0 μm or more and 10.0 μm or less, more preferably 1.5 μm or more and 9.5 μm or less, and further preferably 2.0 μm or more and 9.0 μm or less. Other embodiments of the range of the Smp include 1.0 μm or more and 9.5 μm or less, 1.0 μm or more and 9.0 μm or less, 1.5 μm or more and 10.0 μm or less, 1.5 μm or more and 9.0 μm or less, 2.0 μm or more and 10.0 μm or less, and 2.0 μm or more and 9.5 μm or less.

When the Smp is 1.0 μm or more, the scratch resistance of the optical laminate can be easily improved. When the Smp is 10.0 μm or less, the anti-glare properties of the optical laminate can be easily improved.

Herein, the three-dimensional mean peak spacing Smp is obtained as follows. Assuming that the number of peaks is Ps, where one peak is defined as a region enclosed by a single boundary and positioned above a reference plane on a three-dimensional roughness surface, and that a total area of the measurement region (reference plane) is denoted as A, the Smp is calculated in accordance with the following expression:

$$Smp = \sqrt{\frac{A}{Ps}} \qquad [ Expression 2 ]$$

The Sa and Smp are measured with an interference microscope. An example of the interference microscope includes “NewView” series available from Zygo. Furthermore, the Sa and Smp can be easily calculated using “MetroPro,” measurement and analysis application software attached to the interference microscope, “NewView” series.

Herein, unless otherwise specified, the surface shape (Sa, Smp), and optical properties (R_{SCI}, haze, total light transmittance, transmitted image clarity, etc.) mean an average of 14 measurement values, excluding the maximum and minimum values, from values at 16 measurement points.

Herein, the 16 measurement points are preferably centered around 16 intersection points obtained by excluding a 1 cm margin from the outer edge of a measurement sample, and then drawing lines that divide the remaining region into five equal parts both vertically and horizontally. For example, when the measurement sample is rectangular, after excluding a 0.5 cm margin from the outer edge of the rectangle, the measurement is performed centered around the 16 intersection points of dashed lines that divide the remaining region into five equal parts both vertically and horizontally. It is preferable to use, as the parameter value, the average of 14 measurement values, excluding the maximum and minimum values, out of the measurement values at the 16 measurement points. When the measurement sample is in a shape other than rectangular, such as a circular, elliptical, triangular, or pentagonal shape, it is preferable to draw a rectangle inscribed within such a shape and perform the measurement at 16 points on that rectangle using the method described above.

### <Optical Characteristics>

The optical laminate has a total light reflectance R_{SCI}, measured by a method described below, of preferably less than 1.50%. The total light reflectance (R_{SCI}) refers to a reflectance measured by SCI method. SCI stands for Specular Component Include.

[Measurement of Total Light Reflectance (R_{SCI})]A sample is prepared by laminating a black plate onto the second side of the optical laminate via a transparent adhesive. The total light reflectance (R_{SCI}) of the sample is then measured, with the optical laminate side used as a light incident surface.

When the R_{SCI} is less than 1.50%, blackness of a black display area can be easily enhanced in environments where strong illumination light does not enter the first side, and thus, contrast can be easily improved. The R_{SCI} of the optical laminate is more preferably 1.45% or less, and further preferably 1.43% or less. The lower limit of the R_{SCI} of the optical laminate is not especially limited, and is usually 0.1% or more.

SCI stands for Specular Component Include, and refers to reflected light that includes a specular reflection component from a sample in received reflected light.

A SCI measurement device is configured in accordance with geometric condition d of JIS Z8722: 2009.

### <Geometric Condition d of JIS Z8722: 2009>

A sample is illuminated with a single beam of light where the optical axis does not exceed 10° from the normal to a sample surface, and light reflected in all directions is collected and received. Additionally, in this case, the illuminating light beam must not include a ray with an inclination of 5° or more relative to the central axis thereof.

A difference between the refractive index of the transparent adhesive of the sample and the refractive index of the layer on the second side of the optical laminate is preferably 0.05 or less, more preferably 0.03 or less, and further preferably 0.01 or less. A difference between the refractive index of the transparent adhesive of the sample and the refractive index of the binder resin of the black plate is preferably 0.05 or less, more preferably 0.03 or less, and further preferably 0.01 or less.

The optical laminate preferably has a total light transmittance in accordance with JIS K7361-1:1997 of 80% or more, more preferably 85% or more, and still more preferably 90% or more.

The light incident surface for measuring total light transmittance and haze is the second side of the optical laminate.

The optical laminate has a haze in accordance with JIS K7136:2000 of preferably 20% or more and 75% or less. The lower limit of the haze is more preferably 30% or more, and further preferably 40% or more, and the upper limit is more preferably 70% or less, and further preferably 65% or less.

When the haze is set to 20% or more, the anti-glare properties can be easily improved. When the haze is set to 75% or less, deterioration in image resolution can be easily suppressed.

Embodiments of the range of the haze include 20% or more and 75% or less, 20% or more and 70% or less, 20% or more and 65% or less, 30% or more and 75% or less, 30% or more and 70% or less, 30% or more and 65% or less, 40% or more and 75% or less, 40% or more and 70% or less, and 40% or more and 65% or less.

The optical laminate preferably has an internal haze of 20% or less, more preferably 15% or less, and still more preferably 10% or less in order to facilitate better image resolution and contrast.

Internal haze can be measured by a general-purpose method, for example, by laminating a transparent sheet on the first surface of the optical laminate via a transparent self-adhesive layer to flatten the unevenness of the first surface.

As for a transmitted image clearness of the optical laminate measured in accordance with JIS K7374:2007, when a transmitted image clearness with a width of an optical comb of 0.125 mm is defined as C_{0.125}, a transmitted image clearness with a width of an optical comb of 0.25 mm is defined as C_{0.25}, a transmitted image clearness with a width of an optical comb of 0.5 mm is defined as C_{0.5}, a transmitted image clearness with a width of an optical comb of 1.0 mm is defined as C_{1.0}, and a transmitted image clearness with a width of an optical comb of 2.0 mm is defined as C_{2.0}, values of C_{0.125}, C_{0.25}, C_{0.5}, C_{1.0}, and C_{2.0} are preferably within the following ranges.

To improve the anti-glare properties, C_{0.125} is preferably 50% or less, more preferably 40% or less, more preferably 30% or less, and more preferably 20% or less. To improve the resolution, C_{0.125} is preferably 1.0% or more. Embodiments of the range of C_{0.125} include 1.0% or more and 50% or less, 1.0% or more and 40% or less, 1.0% or more and 30% or less, and 1.0% or more and 20% or less.

To improve the anti-glare properties, C_{0.25} is preferably 50% or less, more preferably 40% or less, more preferably 30% or less, and more preferably 20% or less. To improve the resolution, C_{0.25} is preferably 1.0% or more. Embodiments of the range of C_{0.25} include 1.0% or more and 50% or less, 1.0% or more and 40% or less, 1.0% or more and 30% or less, and 1.0% or more and 20% or less.

To improve the anti-glare properties, C_{0.5} is preferably 50% or less, more preferably 40% or less, more preferably 30% or less, and more preferably 20% or less. To improve the resolution, C_{0.5} is preferably 1.0% or more. Embodiments of the range of C_{0.5} include 1.0% or more and 50% or less, 1.0% or more and 40% or less, 1.0% or more and 30% or less, and 1.0% or more and 20% or less.

To improve the anti-glare properties, C_{1.0} is preferably 50% or less, more preferably 40% or less, more preferably 30% or less, and more preferably 20% or less. To improve the resolution, C_{1.0} is preferably 1.0% or more. Embodiments of the range of C_{1.0} include 1.0% or more and 50% or less, 1.0% or more and 40% or less, 1.0% or more and 30% or less, and 1.0% or more and 20% or less.

To improve the anti-glare properties, C_{2.0} is preferably 50% or less, more preferably 40% or less, more preferably 30% or less, and more preferably 20% or less. To improve the resolution, C_{2.0} is preferably 5.0% or more. Embodiments of the range of C_{2.0} include 5.0% or more and 50% or less, 5.0% or more and 40% or less, 5.0% or more and 30% or less, and 5.0% or more and 20% or less.

To improve the anti-glare properties of the optical laminate, a total of C_{0.125}, C_{0.5}, C_{1.0}, and C_{2.0} is preferably 200% or less, more preferably 150% or less, more preferably 100% or less, and more preferably 80% or less. To improve the resolution, the total is preferably 10.0% or more. Embodiments of a range of the total include 10.0% or more and 200% or less, 10.0% or more and 150% or less, 10.0% or more and 100% or less, and 10.0% or more and 80% or less.

### <Size, Shape, and the Like>

The optical laminate may be in the form of a sheet cut into a predetermined size, or may be in the form of a roll obtained by winding a long sheet. The size of the sheet is not particularly limited, but the maximum size is about 2 inches or more and 500 inches or less. The “maximum size” refers to the maximum length of any two points of the optical laminate when connected. For example, when the optical laminate is rectangular, the diagonal line of the region is the maximum size. When the optical laminate is circular, the diameter of the circle is the maximum size.

The width and length of the roll are not particularly limited, but generally, the width is 500 mm or more and 3000 mm or less and the length is about 500 μm or more and 5000 μm or less. The optical laminate in the form of a roll may be cut into a sheet according to the size of an image display device or the like. At the time of cutting, it is preferable to exclude the end portion of the roll where the physical properties are not stable.

The shape of the sheet is not particularly limited, and examples thereof include polygons such as triangles, quadrilaterals, and pentagons, circles, and random irregular shapes. More specifically, when the optical laminate has a square shape, the aspect ratio is not particularly limited as long as there is no problem as a display screen. For example, the aspect ratio may be horizontal:vertical=1:1, 4:3, 16:10, 16:9, 2:1, or the like, however, the aspect ratio is not limited to such an aspect ratio in in-vehicle applications and digital signage which are rich in design.

The surface shape of the optical laminate on the second side is not particularly limited, but is preferably substantially smooth. Substantially smooth means that arithmetic mean roughness Ra, as defined by JIS B0601: 1994, at a cutoff value of 0.8 mm is less than 0.03 m, and is preferably 0.02 μm or less.

### [Polarizing Plate]

The polarizing plate of the present disclosure is a polarizing plate comprising:
a polarizer;
a first transparent protective plate disposed on one side of the polarizer; and
a second transparent protective plate disposed on the other side of the polarizer, wherein
at least one of the first transparent protective plate and the second transparent protective plate is the aforementioned optical laminate of the present disclosure, and the second side of the optical laminate and the polarizer are disposed so as to face each other.

### <Polarizer>

Examples of the polarizer include: sheet-type polarizers such as a polyvinyl alcohol film, a polyvinyl formal film, a polyvinyl acetal film, and an ethylene-vinyl acetate copolymer saponified film, which are dyed with iodine, etc., and stretched; wire-grid-type polarizers composed of many metal wires arranged in parallel; coated-type polarizers coated with a lyotropic liquid crystal or a dichromatic guest-host material; and multilayer thin-film-type polarizers. These polarizers may be reflective polarizers having a function of reflecting a polarized component not transmitted.

### <Transparent Protective Plate>

The first transparent protective plate is disposed on one side of the polarizer, and the second transparent protective plate is disposed on the other side. At least one of the first transparent protective plate and the second transparent protective plate is the aforementioned optical laminate of the present disclosure.

The polarizing plate of the present disclosure may be a polarizing plate in which one of the first transparent protective plate and the second transparent protective plate is the aforementioned optical laminate of the present disclosure, or may be a polarizing plate in which both the first transparent protective plate and the second transparent protective plate are the aforementioned optical laminates of the present disclosure.

As the transparent protective plate other than the optical laminate of the present disclosure among the first transparent protective plate and the second transparent protective plate, general-purpose plastic films and glass can be used.

The polarizer and the transparent protective plate are preferably laminated via an adhesive. A general-purpose adhesive can be used as the adhesive, and a PVA-based adhesive is preferred.

### [Surface Plate for Image Display Device]

A surface plate for an image display device of the present disclosure is a surface plate for an image display device, the surface plate comprising: a resin plate or a glass plate; and a protective film bonded to the resin plate or the glass plate, wherein the protective film is the aforementioned optical laminate of the present disclosure, and the second side of the optical laminate and the resin plate or the glass plate are disposed so as to face each other.

As the resin plate or the glass plate, resin plates or glass plates generally used as a surface plate of an image display device can be used.

To improve the strength, a thickness of the resin plate or the glass plate is preferably 10 μm or more. An upper limit of the thickness of the resin plate or the glass plate is typically 5000 μm or less. The upper limit of the thickness of the resin plate or the glass plate is preferably 1000 μm or less, more preferably 500 μm or less, and further preferably 100 μm or less for thinning.

Embodiments of a range of the thickness of the resin plate or the glass plate is 10 μm or more and 5000 μm or less, 10 μm or more and 1000 μm or less, 10 μm or more and 500 μm or less, and 10 μm or more and 100 μm or less.

### [Image Display Panel]

An image display panel of the present disclosure is an image display panel comprising: a display element; and a laminate disposed on a light-emitting surface side of the display element, wherein the image display panel comprises the aforementioned optical laminate of the preset disclosure as the optical laminate (see FIG. 2).

In the image display panel, the optical laminate of the present disclosure is preferably disposed to have the second side facing the display element side.

In the image display panel, the optical laminate of the present disclosure is preferably disposed on the outermost surface on a light-emitting surface side of the display element.

Examples of the display element include EL display elements such as an organic EL display element and an inorganic EL display element, a liquid crystal display element, and a plasma display element, and further include an LED display element such as a micro LED display element. These display elements may have a touch panel function inside the display element.

Examples of the liquid crystal display method of the liquid crystal display element includes an IPS method, a VA method, a multi-domain method, an OCB method, an STN method, and a TSTN method.

The image display panel of the present disclosure may be an image display panel with a touch panel having the touch panel between the display element and the optical laminate.

The size of the image display panel is not particularly limited, but the maximum size is about 2 inches or more and 500 inches or less. The maximum size refers to the maximum length of any two points within the surface of the image display panel.

### [Image Display Device]

The image display device of the present disclosure comprises the image display panel of the present disclosure.

The image display device of the present disclosure is not particularly limited as long as the image display device comprises the image display panel of the present disclosure. The image display device of the present disclosure preferably has: the image display panel of the present disclosure; a driving control part electrically connected to the image display panel; and a housing that houses these members.

When the display element is a liquid crystal display element, the image display device of the present disclosure requires a backlight. The backlight is disposed opposite to the light-emitting surface side of the liquid crystal display element.

The size of the image display device is not particularly limited, but the maximum size of the effective display region is about 2 inches or more and 500 inches or less.

The effective display region of an image display device is an area in which an image can be displayed. For example, when the image display device has a housing that surrounds the display element, the region inside the housing becomes the effective image region.

The maximum size of the effective image region refers to the maximum length of any two points within the effective image region when connected. For example, when the effective image region is rectangular, the diagonal line of the region is the maximum size. When the effective image region is circular, the diameter of the region is the maximum size.

The present disclosure includes the following <1> to <17>.
<1> An optical laminate comprising a first side and a second side on the opposite side to the first side, wherein
   the optical laminate comprises a low refractive index layer and an anti-glare layer in this order, from the first side to the second side,
   the low refractive index layer comprises a binder resin and spherical particles having an average particle size of 20 nm or more,
   the first side has an uneven shape,
   an “average occupied area ratio of the spherical particles having an average particle size of 20 nm or more” calculated through the following Measurement 1 is 15.0% or more, and
   an “average film thickness of the low refractive index layer” is 200 nm or less and an “average standard deviation of a film thickness of the low refractive index layer” is 25.0 nm or less, calculated through the following Measurement 2.

### <Measurement 1>

(1-1) A surface on the first side of the optical laminate is imaged with a scanning electron microscope. An imaging area is adjusted in such a manner that a region excluding a scale bar is 50.79 μm in width×38.10 μm in height. The region of 50.79 μm in width×38.10 μm in height is further adjusted to have a pixel number of 1280 pixels×890 pixels.
(1-2) An image of the region of 50.79 μm in width×38.10 μm in height of the (1-1) is divided into 256 gradations, with a darkest part set to 0 and a brightest part set to 255.

The image of the region of 50.79 μm in width×38.10 μm in height of the (1-1) is divided into “10 in width×10 in height=100” small regions.

A standard deviation of the gradations is calculated for each of 64 small regions, excluding 36 small regions located on an outer periphery, out of the 100 small regions.

A small region with a largest standard deviation of the gradations among the 64 small regions is specified.

Among the 64 small regions, “3 in width×3 in height=9” small regions centered around the small region with the largest standard deviation of the gradations are regarded as a convex portion of the low refractive index layer and a neighboring region thereof.

(1-3) The “convex portion and a neighboring region thereof” of the (1-2) is further divided into “10 in width×10 in height=100” fine regions.

A standard deviation of the gradations is calculated for each of the 100 fine regions. The gradations for step (1-3) use the 256 gradations of the (1-2). A fine region with a largest standard deviation of the gradations is specified among the 100 fine regions.

(1-4) An image of a region of 1270 nm in width×890 nm in height, centered around a center part of the fine region specified in the (1-3), is captured with a scanning electron microscope. A portion of the low refractive index layer within the image of the region of 1270 nm in width×890 nm in height is regarded as a convex portion of the low refractive index layer. A ratio of an area occupied by the spherical particles having an average particle size of 20 nm or more in the region of 1270 nm in width×890 nm in height is calculated.
(1-5) Operations described above in the (1-1) to (1-4) are performed at 20 positions on a surface of the first side of the optical laminate. An average of the ratios of the areas at 18 positions, excluding minimum and maximum values, is defined as the “average occupied area ratio of the spherical particles having an average particle size of 20 nm or more”.

### <Measurement 2>

(2-1) A vertical cross-section of the optical laminate is imaged with a scanning transmission electron microscope. An image is adjusted in such a manner that a region excluding a scale bar is 254 μm in width×178 μm in height.
(2-2) In the image of the region of 254 μm in width×178 μm in height of the (2-1), a position where the low refractive index layer is thickest is specified.
(2-3) An image of a region of 1270 nm in width×890 nm in height, centered around the position specified in the (2-2), is captured with a scanning transmission electron microscope. A portion of the low refractive index layer within the image of the region of 1270 nm in width×890 nm in height is regarded as a concave portion of the low refractive index layer. In the region of 1270 nm in width×890 nm in height, a film thickness of the low refractive index layer and a standard deviation of the film thickness of the low refractive index layer are calculated. The film thickness of the low refractive index layer is defined as an average value of film thicknesses at 25 positions. Similarly, the standard deviation of the film thickness of the low refractive index layer is defined as a standard deviation of the film thicknesses at 25 positions. The 25 positions are selected at 50 nm intervals within a range of the length of 1270 nm in width.
(2-4) Operations described above in the (2-1) to (2-3) are performed at 20 positions on the vertical cross-section of the optical laminate. An average of the film thicknesses and an average of the standard deviations of the film thicknesses at 18 positions, excluding minimum and maximum values, are defined respectively as the “average film thickness of the low refractive index layer” and the “average standard deviation of a film thickness of the low refractive index layer”.
<2> The optical laminate according to <1>, wherein the first side has a three-dimensional arithmetic mean height Sa of 0.30 μm or more and 1.00 μm or less.
<3> The optical laminate according to <1> or <2>, wherein the first side has a three-dimensional mean peak spacing Smp of 1.0 μm or more and 10.0 μm or less.
<4> The optical laminate according to any one of <1> to <3>, wherein the low refractive index layer contains a fine particle linked structure.
<5> The optical laminate according to <4>, wherein the linked structure has an average major axis length of 20 nm or more and 200 nm or less.
<6> The optical laminate according to <4> or <5>, wherein the linked structure is contained in an amount of 10 parts by mass or more and 50 parts by mass or less based on 100 parts by mass of the binder resin.
<7> The optical laminate according to any one of <1> to <3>, wherein the low refractive index layer contains a thermoplastic resin as the binder resin, and contains the thermoplastic resin in an amount of 60% by mass or more with respect to a total amount of the binder resin.
<8> The optical laminate according to <7>, wherein the low refractive index layer further contains, as the binder resin, a cured product of an ionizing radiation-curable resin composition.
<9> The optical laminate according to any one of <1> to <8>, comprising the low refractive index layer, the anti-glare layer, and a substrate in this order from the first side to the second side.
<10> The optical laminate according to any one of <1> to <9>, wherein the anti-glare layer contains a binder resin and particles.
<11> The optical laminate according to <10>, comprising, as the particles in the anti-glare layer, particles having an average particle size of 1.0 μm or more and 10.0 μm or less.
<12> The optical laminate according to any one of <1> to <11>, having a total light reflectance R_{SCI}, measured by a method described below, of less than 1.50%.

### [Measurement of Total Light Reflectance (R_{SCI})]

A sample is prepared by laminating a black plate onto the second side of the optical laminate via a transparent adhesive. The total light reflectance (R_{SCI}) of the sample is then measured, with a side of the optical laminate of the sample used as a light incident surface.

<13> The optical laminate according to any one of <1> to <12>, having haze measured according to JIS K7136: 2000 of 20% or more and 75% or less.
<14> A polarizing plate comprising:
a polarizer;
a first transparent protective plate disposed on one side of the polarizer; and
a second transparent protective plate disposed on the other side of the polarizer, wherein
at least one of the first transparent protective plate and the second transparent protective plate is the optical laminate according to any one of <1> to <13>, and
the second side of the optical laminate and the polarizer are disposed so as to face each other.
   <15> A surface plate for an image display device, the surface plate comprising: a resin plate or a glass plate; and a protective film bonded onto the resin plate or the glass plate, wherein the protective film is the optical laminate according to any one of <1> to <13>, and the second side of the optical laminate and the resin plate or the glass plate are disposed so as to face each other.
   <16> An image display panel comprising: a display element; and an optical laminate disposed on a light-emitting surface side of the display element, wherein the image display panel comprises the optical laminate according to any one of <1> to <13> as the optical laminate.
   <17> An image display device comprising the image display panel according to <16>.

### EXAMPLES

Next, the present disclosure will be described in more detail with reference to Examples, but the present disclosure is not limited by these Examples. “Parts” and “%” are based on mass unless otherwise specified.

### 1. Measurement and Evaluation

The optical laminates of Examples and Comparative Examples were measured and evaluated as follows. The atmosphere during each measurement and evaluation was set at a temperature of 23±5° C., and a relative humidity of 40% or more and 65% or less. In addition, before starting each measurement and evaluation, the target sample was exposed to the atmosphere for 30 minutes or more and 60 minutes or less, and then the measurement and evaluation were performed. The results are shown in Table 1 or 2.

### 1-1. Average Occupied Area Ratio

For the optical laminates of Examples and Comparative Examples, the “average occupied area ratio of spherical particles having an average particle size of 20 nm or more” through Measurement 1 was calculated. As a scanning electron microscope (SEM), trade name SU-9000 available from Hitachi High-Technologies Corporation was used. The detailed procedures of steps (1-1) to (1-5) of Measurement 1 were conducted according to the description given herein. For example, in step (1-4), the area ratio occupied by spherical particles having an average particle size of 20 nm or more in the region of 1270 nm in width×890 nm in length was calculated using a circular shape separation function of trade name “WinROOF version 6.6.0” manufactured by MITANI CORPORATION. The average occupied area ratio calculated through Measurement 1 can be regarded as the “average occupied area ratio of spherical particles having an average particle size of 20 nm or more” in a convex portion of the low refractive index layer.

### 1-2. Average Film Thickness and Average Standard Deviation of Film Thickness

For the optical laminates of Examples and Comparative Examples, the “average film thickness of the low refractive index layer” and the “average standard deviation of a film thickness of the low refractive index layer” through Measurement 2 were calculated. As the scanning transmission electron microscope (STEM), trade name SU-9000 available from Hitachi High-Technologies Corporation was used. The detailed procedures for steps (2-1) to (2-4) of Measurement 2 were conducted according to the description given herein. For example, the film thickness measurement at 50 nm intervals in step (2-3) was performed using “ImageJ 1.53”, public domain image analysis software. The “average film thickness of the low refractive index layer” and the “average standard deviation of a film thickness of the low refractive index layer” calculated through Measurement 2 can be regarded as the “average film thickness of the low refractive index layer” and the “average standard deviation of a film thickness of the low refractive index layer” in a concave portion of the low refractive index layer.

### 1-3. Total Light Reflectance (Reflectance Measured by SCI Method: R_{SCI})

Each of the optical laminates of Examples and Comparative Examples was cut into 10 cm×10 cm pieces. The cutting position was randomly selected after visually confirming the absence of anomalies such as dust or scratches. A substrate side corresponding to the second side of the cut optical laminate was laminated onto a black plate of the size of 10 cm in length×10 cm in width (Kuraray Co., Ltd., trade name: COMOGLAS DFA2CG 502K (black) series, 2 mm thick) via an optical clear adhesive sheet available from PANAC CO., LTD. (trade name: Panaclean PD-S1), and thus, a sample 1 was prepared.

As a measurement device according to geometric conditions d of JIS Z8722: 2009, a spectrophotometer manufactured by Shimadzu Corporation (main unit: UV-3600 Plus, external unit: MPC-603) was prepared.

Using the aforementioned measurement device, a total light reflectance (reflectance measured by the SCI method: R_{SCI}) was measured in the sample 1 from the first side. A total light reflectance (R_{SCI}) of less than 1.50% was considered an acceptable level. Before measuring the total light reflectance of each sample, a baseline measurement was conducted using a standard white plate molded from a barium sulfate powder.

### <Conditions in Aforementioned Measurement Device>

Wavelength range: 780 nm to 380 nm
Scan speed: high
Slit width: 5.0 nm
Sampling pitch: 0.5 nm
Illuminant: C
Field of view: 2 degrees
Standard white plate correction: no
Light source switching wavelength: 360 nm
Detector switching wavelength: 830 nm
S/R switching: invert
Detector selection: auto

### 1-4. Anti-Glare Properties

In a bright room environment, the sample 1, prepared in 1-3, was placed on a horizontal table with a height of 70 cm, with its first side, corresponding to the low refractive index layer side, facing upward. The sample was placed approximately directly beneath an illumination light. The sample was observed from the front (ensuring that an observer did not obstruct the illumination light), and the reflection of the illumination light on an uneven surface was evaluated according to the following evaluation criteria.

A Hf32 type straight tube three-wavelength neutral white fluorescent lamp was used as illumination, and the position of the illumination was 2 μm above the horizontal table in the vertical direction. The evaluation was carried out in a range where the illuminance on the uneven surface of the sample was 500 lux or more and 1000 lux or less. The position of the eyes of the observer was about 120 cm from the floor. Observers were healthy people in their thirties with visual acuity of 0.7 or better.

### <Evaluation Criteria>

A: The outline of the illumination was not visible, and the position thereof was also unknown.
B: The outline of the illumination was not visible, but the position thereof was vaguely discernible.
B⁻: The outline and the position of the illumination were vaguely discernible.
C: The outline of the illumination was slightly blurred, and the position thereof was clearly identifiable.

### 1-5. Scratch Resistance

The sample 1 prepared in 1-3 was used as a sample. The sample 1 was laminated onto a base of a Gakushin-type rubbing tester (trade name “AB-301” manufactured by TESTER SANGYO CO., LTD.) with the first side, corresponding to the low refractive index layer side, facing upward. A steel wool #0000 (available from Nippon Steel Wool Co., Ltd., trade name “Bonstar B-204”) was set. The steel wool was contacted with the surface of the low refractive index layer, and reciprocated ten times at a moving speed of 100 mm/sec and a moving distance per reciprocation of 200 mm with applying a load. The load was set to 300 g/cm². A contact area between the steel wool and the sample was set to 1 cm².

Thereafter, each sample was visually observed under a fluorescent illumination to check the number of scratches and discoloration. In this time, the illuminance on the sample was 800 lux or more and 1200 lux or less, and the observation distance was 30 cm. Observers were healthy people in their thirties with visual acuity of 0.7 or better. The discoloration of the sample is considered to occur because the low refractive index layer is abraded to cause a change in the film thickness.

### <Evaluation Criteria>

A: No scratches or discoloration were observed.
B: No scratches were observed, but discoloration was slightly observed.
C: Scratches and discoloration were clearly observed.

### 1-6. Measurement of Surface Shape

Each of the optical laminates of Examples and Comparative Examples was cut into 10 cm×10 cm pieces. The cutting position was randomly selected after visually confirming the absence of anomalies such as dust or scratches. A transparent substrate side of the cut optical laminate was laminated onto a glass plate of 10 cm in length×10 cm in width (2.0 mm thick) via an optical clear adhesive sheet available from PANAC CO., LTD. (trade name: Panaclean PD-S1, 25 μm thick), and thus, a sample 2 was prepared.

Using a white light interferometry microscope (New View7300, Zygo Corporation), the sample 1 was set on a measurement stage so as to be fixed and in close contact with the measurement stage, and then the surface shape of the optical laminate was measured and analyzed under the following measurement condition 1 and analysis condition 1. As a measurement and analysis software, Microscope Application of MetroPro ver 9.0.10 (64-bit) was used.

### (Measurement Condition 1)

Objective lens: 50×

### Image Zoom: 1×

Measurement region: 218 μm×218 μm
Resolution (spacing per point): 0.22 μm
Instrument: NewView 7000 Id 0 SN 073395
Acquisition Mode: Scan
Scan Type: Bipolar
Camera Mode: 992×992 48 Hz
Subtract Sys Err: Off
SysErr File: SysErr. dat
AGC: Off
Phase Res: High
Connection Order: Location
Discon Action: Filter
Min Mod (%): 0.01
Min Area Size: 7
Remove Fringes: Off
Number of Averages: 0
FDA Noise Threshold: 10
Scan Length: 15 um bipolar (6 sec)
Extended Scan Length: 1000 μm
FDA Res: High 2G

### (Analysis Condition 1)

Removed: None
Data Fill: On
Data Fill Max: 10000
Filter: High Pass
Filter Type: Gauss Spline
Filter Window Size: 3
Filter Trim: Off
Filter Low wavelength: 800 μm
Min Area Size: 0
Remove spikes: On
Spike Height (xRMS): 2.5

Low wavelength corresponds to cutoff value λc in the roughness parameter.

“Ra” was displayed on the Surface Map screen, and respective values were specified as Sa of the respective measurement regions.

Next, “Save Data” button was displayed on the Surface Map screen, and analyzed 3D surface roughness data was saved. Then, the saved data was loaded into Advanced Texture Application, and the following analysis conditions 2 were applied.

### (Analysis Conditions 2)

High FFT Filter: off
Low FFT Filter: off
Calc High Frequency: On
Calc Low Frequency: On
Filter Trim: On
Remove spikes: Off
Spike Height (xRMS): 5.00
Noise Filter Size: 0
Noise Filter Type: 2 Sigma
Fill Data: Off
Data Fill Max: 25
Trim: 0
Trim Mode: All
Remove: Plane
Reference Band: 0 μm
Mim Peaks/Valleys Area: 0 μm²
Max Peaks/Valleys Area: 0 μm²

Subsequently, the “Peaks/Valleys” screen was displayed, and analysis was performed with “Reference Band: 0 μm,” “Mim Peaks/Valleys Area: 0 μm²,” and “Max Peaks/Valleys Area: 0 μm²”, and a numerical value displayed in “Peak Spacing” was then taken as the Smp for each measurement region.

### 1-7. Haze (Hz)

The optical laminates of Examples and Comparative Examples were cut into pieces of 10 cm squares. The cutting site was selected from random sites after visually confirming that there were no abnormal points such as dust and scratches. The haze of JIS K7136:2000 of each sample was measured using a haze meter (HM-150, manufactured by Murakami Color Research Laboratory Co., Ltd.).

In order to stabilize the light source, the power switch of the apparatus was turned on in advance, and then the apparatus was allowed to stand for 15 minutes or more, then calibration was performed without setting anything in the inlet opening, and then a measurement sample was set in the inlet opening and measurement was performed. The light incident surface was on the side of the substrate.

The optical laminates of all Examples and Comparative Examples exhibited a total light transmittance of 90% or more.

### 1-8. Transmitted Image Clearness

The optical laminates of Examples and Comparative Examples were cut into pieces of 10 cm squares. The cutting site was selected from random sites after visually confirming that there were no abnormal points such as dust and scratches. The transmitted image clearness of the samples was measured by using an image clarity measuring device available from Suga Test Instruments Co., Ltd. (trade name: “ICM-1T”) in accordance with JIS K7374:2007. A width of an optical comb was five of 0.125 mm, 0.25 mm, 0.5 mm, 1.0 mm, or 2.0 mm. The light incident surface for the measurement was the substrate side. The values of C_{0.125}, C_{0.25}, C_{0.5}, C_{1.0}, and C_{2.0} and the total value of C_{0.125}, C_{0.5}, C_{1.0}, and C_{2.0} were shown in Table 2.

### 2. Production of Optical Laminate

### Example 1

The following composition for anti-glare layer 1 was applied onto a substrate (triacetyl cellulose resin film of 80 μm in thickness, Fujifilm Corporation). It was dried at 70° C. and a wind velocity of 5 m/s for 30 seconds. Subsequently, the resultant was irradiated with ultraviolet rays in a nitrogen atmosphere having an oxygen concentration of 200 ppm or less so that the integrated light quantity became 100 mJ/cm², and thus, an anti-glare layer having a thickness of 5.0 μm was formed.

Next, a low refractive index layer composition 1 described below was applied onto the anti-glare layer. The resultant was then dried at 70° C. with a wind velocity of 5 m/s for 30 seconds. Subsequently, the resultant was irradiated with ultraviolet rays in a nitrogen atmosphere having an oxygen concentration of 200 ppm or less so that integrated light quantity became 100 mJ/cm², and thus, a low refractive index layer having a thickness of 0.10 μm was formed, resulting in obtaining an optical laminate of Example 1.

### <Anti-Glare Layer Composition 1>

pentaerythritol triacrylate 65 parts by mass (on a solid content basis)
   (Nippon Kayaku Co., Ltd., trade name: KAYARAD-PET-30)
urethane acrylate oligomer 35 parts by mass (on a solid content basis)
   (Mitsubishi Chemical Corporation, trade name: UV-1700B)
silica particles 20 parts by mass (on a solid content basis)
   (average particle size: 4.1 μm)
   (available from FUJI SILYSIA CHEMICAL LTD., gel-method irregularly shaped silica)
organic particles 5 parts by mass (on a solid content basis)
   (Sekisui Kasei Co., Ltd., spherical polyacrylic-styrene copolymer)
   (average particle size 2.0 μm, refractive index 1.515)
photopolymerization initiator 5 parts by mass (on a solid content basis)
   (IGM Resins B.V., trade name: Omnirad184)
silicone leveling agent 0.1 parts by mass (on a solid content basis)
   (Momentive Performance Materials, trade name: TSF4460)
solvent (toluene) 200 parts
solvent (methyl isobutyl ketone (hereinafter referred to as “MIBK”)) 40 parts by mass

### <Low Refractive Index Layer Composition 1>

hollow silica fine particles 175 parts by mass (on a solid content basis)
   (average primary particle size: 75 nm)
solid silica fine particles 25 parts by mass (on a solid content basis)
   (silica fine particle linked structure having an average major axis length of 50 nm; see below for the production method)
hexafunctional acrylate monomer 100 parts by mass (on a solid content basis)
   (DPHA, manufactured by Sartomer Company, Inc.)
photopolymerization initiator 7.0 parts by mass (on a solid content basis)
   (IGMResins B.V., trade name: Omnirad 127)
silicone-based leveling agent: 10 parts by mass (on a solid content basis)
   (X-22-164E: manufactured by Shin-Etsu Chemical Co., Ltd.)
MIBK 16367 parts by mass

### <Preparation of Solid Silica Fine Particles Used in Example 1>

According to a method described in Example 6 of JP 2010-143784 A, 250 parts by mass of a silica sol having a SiO₂ concentration of 15% by mass, a converted particle size of 5 to 6 nm, and a pH of 10.5 was placed into a 300 mL SUS autoclave, and a growth reaction was carried out at 150° C. for 1 hour under stirring. The surface of solid silica fine particles in the thus obtained silica sol was then modified with 6.2 parts by mass of a silane coupling agent (trade name: KBM-503, Shin-Etsu Chemical Co., Ltd.). Next, the solvent was replaced with MIBK to obtain a silica sol containing the solid silica fine particles. The solid silica fine particles in the obtained silica sol formed a linked structure with an average major axis length of 50 nm.

### Example 2

An optical laminate of Example 2 was obtained in the same manner as in Example 1 except that the low refractive index layer composition 1 was changed to a low refractive index layer composition 2 described below.

### <Low Refractive Index Layer Composition 2>

hollow silica fine particles 175 parts by mass (on a solid content basis)
   (average primary particle size: 75 nm)
solid silica fine particles 25 parts by mass (on a solid content basis)
   (average primary particle size: 12.5 nm)
   (particles surface-treated with a silane coupling agent having a methacryl group;
   note: These solid silica particles do not possess a linked structure.)
hexafunctional acrylate monomer 30 parts by mass (on a solid content basis)
   (DPHA, manufactured by Sartomer Company, Inc.)
PMMA polymer 70 parts by mass (on a solid content basis)
   (weight-average molecular weight 75000, manufactured by Mitsubishi Chemical Corporation)
photopolymerization initiator 7.0 parts by mass (on a solid content basis)
   (IGMResins B.V., trade name: Omnirad 127)
silicone-based leveling agent 10 parts by mass (on a solid content basis) (X-22-164E: manufactured by Shin-Etsu Chemical Co., Ltd.)
MIBK 16367 parts by mass

### Example 3

An optical laminate of Example 3 was obtained in the same manner as in Example 1 except that the solid silica fine particles in the low refractive index layer composition 1 were changed to a silica fine particle linked structure having an average major axis length of 35 nm.

### <Preparation of Solid Silica Fine Particles Used in Example 3>

A silica sol containing solid silica fine particles was obtained in the same manner as in Example 1 except that the growth reaction of Example 1 was changed to be performed at 130° C. for 1 hour. The solid silica fine particles in the obtained silica sol formed a linked structure having an average major axis length of 35 nm.

### Example 4

An optical laminate of Example 4 was obtained in the same manner as in Example 1 except that the solid silica fine particles in the low refractive index layer composition 1 was changed to a silica fine particle linked structure having an average major axis length of 100 nm.

### <Preparation of Solid Silica Fine Particles Used in Example 4>

A silica sol containing solid silica fine particles was obtained in the same manner as in Example 1 except that the growth reaction of Example 1 was changed to be performed at 150° C. for 2 hours. The solid silica fine particles in the obtained silica sol formed a linked structure having an average major axis length of 100 nm.

### Example 5

As an anti-glare layer composition of Example 5, one obtained by adding, to the anti-glare layer composition 1, 5 parts by mass, on a solid content basis, of second silica particles (average particle size: 6.0 μm, manufactured by Fuji Silysia Chemical Ltd.) was used. Furthermore, the thickness of the anti-glare layer was changed to 6.2 μm. Except for these changes, an optical laminate of Example 5 was obtained in the same manner as in Example 1.

### Example 6

As an anti-glare layer composition of Example 6, one obtained by changing the silica particles having an average particle size of 4.1 μm used in the anti-glare layer composition 1 to silica particles having an average particle size of 3.0 μm (manufactured by Fuji Silysia Chemical Ltd.) was used. A content of the silica particles having an average particle size of 3.0 μm was set to 15 parts by mass on a solid content basis. Additionally, the thickness of the anti-glare layer was changed to 3.5 μm. Except for these changes, an optical laminate of Example 6 was obtained in the same manner as in Example 1.

### Example 7

As an anti-glare layer composition of Example 6, one obtained by changing the silica particles having an average particle size of 4.1 μm used in the anti-glare layer composition 1 to silica particles having an average particle size of 2.5 μm (manufactured by Fuji Silysia Chemical Ltd.) was used. A content of the silica particles having an average particle size of 2.5 μm was set to 18 parts by mass on a solid content basis. Additionally, the thickness of the anti-glare layer was changed to 3.0 μm. Except for these changes, an optical laminate of Example 7 was obtained in the same manner as in Example 1.

### Comparative Example 1

An optical laminate of Comparative Example 1 was obtained in the same manner as in Example 1 except that the solid silica fine particles in the low refractive index layer composition 1 were changed to spherical silica particles surface-treated with a silane coupling agent having a methacryl group, and having an average primary particle size of 12.5 nm.

### Comparative Example 2

An optical laminate of Comparative Example 2 was obtained in the same manner as in Example 1 except that the solid silica fine particles in the low refractive index layer composition 1 were changed to a silica fine particle linked structure having an average major axis length of 500 nm.

### <Preparation of Solid Silica Fine Particles Used in Comparative Example 2>

A silica sol containing solid silica fine particles was obtained in the same manner as in Example 1 except that the growth reaction of Example 1 was changed to be performed at 150° C. for 4 hours. The solid silica fine particles in the obtained silica sol formed a linked structure having an average major axis length of 500 nm.

### Comparative Example 3

An optical laminate of Comparative Example 3 was obtained in the same manner as in Example 2 except that in the low refractive index layer composition 2, the content of the hexafunctional acrylate monomer was changed to 90 parts by mass on a solid content basis, and the content of the PMMA polymer was changed to 10 parts by mass on a solid content basis.

### Comparative Example 4

An optical laminate of Comparative Example 4 was obtained in the same manner as in Example 5 except that the low refractive index layer composition 1 was changed to a low refractive index layer composition 3 described below.

### <Low Refractive Index Layer Composition 3>

hollow silica fine particles 175 parts by mass (on a solid content basis)
   (average primary particle size: 75 nm)
solid silica fine particles 25 parts by mass (on a solid content basis)
   (average primary particle size: 12.5 nm)
   (particles surface-treated with a silane coupling agent having a methacryl group;
   note: These solid silica particles do not possess a linked structure.)
hexafunctional acrylate monomer 100 parts by mass (on a solid content basis)
   (DPHA, manufactured by Sartomer Company, Inc.)
photopolymerization initiator 7.0 parts by mass (on a solid content basis)
   (IGMResins B.V., trade name: Omnirad 127)
silicone-based leveling agent 10 parts by mass (on a solid content basis)
   (X-22-164E: manufactured by Shin-Etsu Chemical Co., Ltd.)
MIBK 16367 parts by mass

TABLE 1

| | | | Measurement 2 | | | | | | | | | | | | |
|---|---|---|---|---|---|---|---|---|---|---|---|---|---|---|---|
| | | | | Average | | | | | | | | | | | |
| | | Measure- | | standard | | | | | | | | | | | |
| | | ment 1 | Average | deviation | | | | Surface | | | | | | | |
| | | Average | film | of film | Total light | Anti- | | shape | | | | | | | |
| | | occupied | thickness | thickness | reflectance | glare | Scratch | Sa | Smp | Hz | Transmitted image clarity (%) | | | | |
| | | area (%) | (nm) | (nm) | (%) | properties | resistance | (μm) | (μm) | (%) | C_{0.125} | C_{0.25} | C_{0.5} | C_{1.0} | C_{2.0} |
| Example | 1 | 32.4 | 99 | 6.9 | 1.39 | A | A | 0.60 | 2.9 | 51.6 | 2.8 | 3.8 | 2.5 | 2.6 | 9.6 |
| | 2 | 22.8 | 128 | 9.4 | 1.40 | A | B | 0.60 | 3.0 | 51.3 | 3.0 | 3.2 | 2.9 | 3.0 | 10.0 |
| | 3 | 32.7 | 110 | 13.1 | 1.41 | A | A | 0.59 | 2.9 | 51.1 | 3.0 | 3.8 | 2.9 | 2.6 | 9.1 |
| | 4 | 27.0 | 90 | 23.7 | 1.40 | A | A | 0.60 | 2.9 | 51.6 | 3.0 | 3.4 | 2.8 | 3.0 | 9.5 |
| | 5 | 18.2 | 108 | 15.2 | 1.45 | A | B | 1.10 | 4.1 | 71.5 | 2.8 | 3.5 | 3.8 | 4.6 | 11.8 |
| | 6 | 31.5 | 99 | 7.5 | 1.29 | B | A | 0.20 | 12.4 | 26.8 | 16.9 | 15.1 | 16.3 | 19.3 | 32.8 |
| | 7 | 32.4 | 103 | 6.8 | 1.24 | B | A | 0.15 | 16.2 | 20.3 | 22.0 | 20.7 | 21.1 | 24.7 | 40.1 |
| Comparative | 1 | 13.8 | 145 | 10.7 | 1.50 | A | A | 0.59 | 2.9 | 51.3 | 2.8 | 2.9 | 2.6 | 3.4 | 8.7 |
| Example | 2 | 35.3 | 234 | 31.3 | 1.86 | A | B | 0.61 | 3.0 | 50.6 | 2.9 | 2.6 | 2.5 | 3.2 | 8.8 |
| | 3 | 14.1 | 150 | 13.8 | 1.72 | A | A | 0.59 | 2.9 | 52.5 | 2.7 | 3.4 | 3.0 | 3.0 | 9.0 |
| | 4 | 11.3 | 176 | 17.9 | 2.14 | A | C | 1.08 | 4.0 | 71.8 | 2.9 | 3.6 | 3.8 | 4.8 | 11.6 |

Referring to the results shown in Table 1, in the optical laminates of Examples, the “average occupied area ratio of spherical particles having an average particle size of 20 nm or more” is 15.0% or more, the “average film thickness of the low refractive index layer” is 200 nm or less, and the “average standard deviation of a film thickness of the low refractive index layer” is 25.0 nm or less. Thus, it can be confirmed that the optical laminates of Examples have lower total light reflectance (R_{SCI}), and better anti-reflection properties compared to the optical laminates of Comparative Examples.

### REFERENCE SIGNS LIST

10: substrate
20: anti-glare layer
30: low refractive index layer
100: optical laminate
110: display element
120: image display panel

1. An optical laminate comprising a first side and a second side on the opposite side to the first side, wherein
the optical laminate comprises a low refractive index layer and an anti-glare layer in this order, from the first side to the second side,
the low refractive index layer comprises a binder resin and spherical particles having an average particle size of 20 nm or more,
the first side has an uneven shape,
an “average occupied area ratio of the spherical particles having an average particle size of 20 nm or more” calculated through the following Measurement 1 is 15.0% or more, and an “average film thickness of the low refractive index layer” is 200 nm or less and an “average standard deviation of a film thickness of the low refractive index layer” is 25.0 nm or less, calculated through the following Measurement 2:
<Measurement 1>
(1-1) a surface on the first side of the optical laminate is imaged with a scanning electron microscope; an imaging area is adjusted in such a manner that a region excluding a scale bar is 50.79 μm in width×38.10 μm in height; the region of 50.79 μm in width×38.10 μm in height is further adjusted to have a pixel number of 1280 pixels×890 pixels;
(1-2) an image of the region of 50.79 μm in width×38.10 μm in height of the (1-1) is divided into 256 gradations, with a darkest part set to 0 and a brightest part set to 255; the image of the region of 50.79 μm in width×38.10 μm in height of the (1-1) is divided into “10 in width×10 in height=100” small regions; a standard deviation of the gradations is calculated for each of 64 small regions, excluding 36 small regions located on an outer periphery, out of the 100 small regions; a small region with a largest standard deviation of the gradations among the 64 small regions is specified; and among the 64 small regions, “3 in width×3 in height=9” small regions centered around the small region with the largest standard deviation of the gradations are regarded as a convex portion of the low refractive index layer and a neighboring region thereof;
(1-3) the “convex portion and a neighboring region thereof” of the (1-2) is further divided into “10 in width×10 in height=100” fine regions; a standard deviation of the gradations is calculated for each of the 100 fine regions; the gradations for step (1-3) use the 256 gradations of the (1-2); and a fine region with a largest standard deviation of the gradations is specified among the 100 fine regions;
(1-4) an image of a region of 1270 nm in width×890 nm in height, centered around a center part of the fine region specified in the (1-3), is captured with a scanning electron microscope; a portion of the low refractive index layer within the image of the region of 1270 nm in width×890 nm in height is regarded as a convex portion of the low refractive index layer; and a ratio of an area occupied by the spherical particles having an average particle size of 20 nm or more in the region of 1270 nm in width×890 nm in height is calculated; and
(1-5) operations described above in the (1-1) to (1-4) are performed at 20 positions on a surface of the first side of the optical laminate; and an average of the ratios of the areas at 18 positions, excluding minimum and maximum values, is defined as the “average occupied area ratio of the spherical particles having an average particle size of 20 nm or more”;
<Measurement 2>
(2-1) a vertical cross-section of the optical laminate is imaged with a scanning transmission electron microscope; and an image is adjusted in such a manner that a region excluding a scale bar is 254 μm in width×178 μm in height;
(2-2) in the image of the region of 254 μm in width×178 μm in height of the (2-1), a position where the low refractive index layer is thickest is specified;
(2-3) an image of a region of 1270 nm in width×890 nm in height, centered around the position specified in the (2-2), is captured with a scanning transmission electron microscope; a portion of the low refractive index layer within the image of the region of 1270 nm in width×890 nm in height is regarded as a concave portion of the low refractive index layer; in the region of 1270 nm in width×890 nm in height, a film thickness of the low refractive index layer and a standard deviation of the film thickness of the low refractive index layer are calculated; the film thickness of the low refractive index layer is defined as an average value of film thicknesses at 25 positions; similarly, the standard deviation of the film thickness of the low refractive index layer is defined as a standard deviation of the film thicknesses at 25 positions; and the 25 positions are selected at 50 nm intervals within a range of the length of 1270 nm in width; and
(2-4) operations described above in the (2-1) to (2-3) are performed at 20 positions on the vertical cross-section of the optical laminate; and an average of the film thicknesses and an average of the standard deviations of the film thicknesses at 18 positions, excluding minimum and maximum values, are defined respectively as the “average film thickness of the low refractive index layer” and the “average standard deviation of the film thickness of the low refractive index layer”.

2. The optical laminate according to claim 1, wherein the first side has a three-dimensional arithmetic mean height Sa of 0.30 μm or more and 1.00 μm or less.

3. The optical laminate according to claim 1, where the first side has a three-dimensional mean peak spacing Smp of 1.0 μm or more and 10.0 μm or less.

4. The optical laminate according to claim 1, wherein the low refractive index layer comprises a fine particle linked structure.

5. The optical laminate according to claim 4, wherein the linked structure has an average major axis length of 20 nm or more and 200 nm or less.

6. The optical laminate according to claim 4, wherein the linked structure is contained in an amount of 10 parts by mass or more and 50 parts by mass or less based on 100 parts by mass of the binder resin.

7. The optical laminate according to claim 1, wherein the low refractive index layer contains a thermoplastic resin as the binder resin, and contains the thermoplastic resin in an amount of 60% by mass or more with respect to a total amount of the binder resin.

8. The optical laminate according to claim 7, wherein the low refractive index layer further comprises, as the binder resin, a cured product of an ionizing radiation-curable resin composition.

9. The optical laminate according to claim 1, comprising the low refractive index layer, the anti-glare layer, and a substrate in this order from the first side to the second side.

10. The optical laminate according to claim 1, wherein the anti-glare layer comprises a binder resin and particles.

11. The optical laminate according to claim 10, comprising, as the particles in the anti-glare layer, particles having an average particle size of 1.0 μm or more and 10.0 μm or less.

12. The optical laminate according to claim 1, having a total light reflectance R_{SCI} measured by a method described below of less than 1.50%:
[Measurement of total light reflectance (R_{SCI})]
a sample is prepared by laminating a black plate onto the second side of the optical laminate via a transparent adhesive; and the total light reflectance (R_{SCI}) of the sample is then measured, with a side of the optical laminate of the sample used as a light incident surface.

13. The optical laminate according to claim 1, having haze measured according to JIS K7136: 2000 of 20% or more and 75% or less.

14. A polarizing plate comprising:
a polarizer;
a first transparent protective plate disposed on one side of the polarizer; and
a second transparent protective plate disposed on the other side of the polarizer, wherein
at least one of the first transparent protective plate and the second transparent protective plate is the optical laminate according to claim 1, and
the second side of the optical laminate and the polarizer are disposed so as to face each other.

15. A surface plate for an image display device, the surface plate comprising:
a resin plate or a glass plate; and
a protective film bonded to the resin plate or the glass plate, wherein
the protective film is the optical laminate according to claim 1, and
the second side of the optical laminate and the resin plate or the glass plate are disposed so as to face each other.

16. An image display panel comprising:
a display element; and
an optical laminate disposed on a light-emitting surface side of the display element, wherein
the image display panel comprises, as the optical laminate, the optical laminate according to claim 1.

17. An image display device comprising the image display panel according to claim 16.
